(19) United States
(12) Patent Application Publication
(10) Pub. No.: US 2025/0323940 A1
(43) Pub. Date: Oct. 16, 2025

(54) SYSTEMS AND METHODS FOR CORRESPONDENCE FRAUD MITIGATION

(71) Applicant: Wells Fargo Bank, N.A., San Francisco, CA (US)

(72) Inventors: Leo Rinaldi, Matthews, NC (US); Kathryn Lynne Sanders, Charlotte, NC (US); Jaclyn Olmos-Lym, San Francisco, CA (US); Tanisha Patterson-Powe, Huntersville, NC (US); Kelvin Hay, Hattiesburg, MS (US); Robin Fulmer, Alvord, TX (US)

(21) Appl. No.: 18/637,146

(22) Filed: Apr. 16, 2024

(51) Int. Cl. H04L 9/40

(52) U.S. Cl. CPC H04L 63/1483; H04L 63/1425; H04L 63/205

(57) ABSTRACT

Systems, apparatuses, methods, and computer program products are disclosed for mitigating correspondence fraud. An example method includes receiving candidate correspondence associated with a user and extracting one or more correspondence content data features from the candidate correspondence. The example method further includes determining, based on the one or more correspondence content data features, a set of fraud patterns associated with the candidate correspondence and determining, based on the set of fraud patterns, a fraud classification for the candidate correspondence. The example method further includes generating, based on the fraud classification, a first set of fraud deterrence recommendations and providing the first set of fraud deterrence recommendations to one or more computing devices.

### BACKGROUND

Schemes to defraud individuals have become increasingly sophisticated, and fraudsters have devised many tactics designed to deceive individuals into providing sensitive data, personal information, and/or valuable resources. Furthermore, conventional fraud mitigation systems and techniques exhibit numerous drawbacks, inefficiencies, and limitations.

### BRIEF SUMMARY

There currently exists a multitude of different correspondence fraud schemes that are constantly evolving, thereby making it difficult to provide effective education and/or forewarning to users who may receive fraudulent correspondence. Furthermore, different correspondence fraud tactics may solicit different responses from a user. For instance, fraudsters may generate fraudulent correspondence that targets a respective user by misleading them to take certain actions, reveal certain sensitive information, and/or otherwise respond to the fraudulent correspondence in a manner that puts the user and/or the user's data at risk (e.g., provide sensitive data, account data, access to resources, proprietary information, and/or the like).

Exacerbating these technological problems is the fact that, historically, enterprises (e.g., financial institutions, banks, corporations, and/or the like) have not had an efficient, effective way to assure users that the correspondence the users have received in the name of the enterprise is indeed authentic and trustworthy. As such, the conventional means for verifying the authenticity of correspondence received from a respective enterprise result in high costs, wasted technological resources, and loss of trust. For example, with respect to physical correspondence received by mail, conventional fraud mitigation techniques may require a user to contact respective enterprise personnel (e.g., via telephone, by email, in writing, etc.) to inquire as to whether a respective correspondence (e.g., a physical letter) is authentic. Such inefficiencies may lead a user to disregarding potentially authentic correspondence or, worse, taking one or more actions based on fraudulent correspondence that result in the loss of sensitive data, personal information, and/or valuable resources. Thus, it may be beneficial not only to determine whether a respective correspondence is fraudulent, but further to determine a particular fraud classification for a respective correspondence such that responsive action recommendations effective against the particular fraud classification may be provided to and/or executed on behalf of the user.

In contrast to conventional techniques for detecting fraudulent correspondence, example embodiments described herein comprise a correspondence fraud mitigation system configured to provide dynamic correspondence fraud mitigation. In example embodiments, the correspondence fraud mitigation system may, at least in part, (i) receive candidate correspondence associated with a user; (ii) extract one or more correspondence content data features from the candidate correspondence; (iii) determine, based on the one or more correspondence content data features, a set of fraud patterns associated with the candidate correspondence; (iv) determine, by the correspondence analysis circuitry and based on the set of fraud patterns, a fraud classification for the candidate correspondence; (v) generate, based on the fraud classification, at least a first set of fraud deterrence recommendations; and (vi) provide the at least first set of fraud deterrence recommendations to a user device associated with the user.

Accordingly, the present disclosure sets forth systems, methods, and apparatuses that provide dynamic correspondence fraud mitigation that is accessible to users. There are many advantages of these, and other embodiments described herein. One advantage the correspondence fraud mitigation system provides, as described herein, is an improvement to the functioning of the computing infrastructure of an enterprise, such as by reducing the burden on computing resources. For instance, the correspondence fraud mitigation system described herein reduces the complexity of authenticating one or more pieces of correspondence by, among other things, automating processes such as submitting a piece of correspondence to a respective enterprise for verification of authenticity, authenticating said piece of correspondence via one or more multi-model, artificial intelligence (AI)-based techniques, and alerting an enterprise representative and/or a user regarding suspected fraudulent correspondence.

Another advantage of the correspondence fraud mitigation system, as described herein, is an improvement to network security technologies and/or authentication technologies by providing an increased security for data, information, and/or valuable resources related to users and/or enterprises by leveraging an AI-based correspondence analysis model to extract one or more correspondence content data features associated with a candidate correspondence and determine, based on the one or more correspondence content data features, a set of fraud patterns associated with the candidate correspondence. Additionally, the correspondence analysis model may be configured to determine a fraud classification for the candidate correspondence based at least in part on the set of fraud patterns. Thus, not only do present embodiments provide an automatic mechanism that allows individual users to determine whether the correspondence is authentic for the user, but also leverages findings of fraudulent correspondence to proactively discover larger fraud patterns. Thus, embodiments herein may also provide proactive warnings and/or alerts to users who have not received the fraudulent correspondence yet but who may be targeted. In this way, embodiments described herein also decrease the risk for future fraud.

Furthermore, the correspondence analysis model may be configured to compare the one or more extracted correspondence content data features to ground-truth data associated with an enterprise. In this regard, the AI-based correspondence fraud mitigation model may be employed to detect correspondence faults associated with various language errors and/or correspondence inconsistencies in the candidate correspondence that may not be readily apparent to a user who has received the candidate correspondence. As a non-limiting example, a user may not be aware of various user data obfuscation rules associated with the enterprise that dictate how much, or in what manner, various user data is to be conveyed in an authentic piece of correspondence. As such, the user may not recognize that their personally identifiable information (PII) and/or account data has been presented in a manner that is inconsistent with the various correspondence rules and guidelines associated with the enterprise.

Additionally, the example embodiments described herein further improve upon conventional fraud mitigation techniques as an AI-based fraud deterrence model described herein may be configured to generate one or more fraud deterrence recommendations for mitigating potential risks associated with fraudulent correspondence. In some example embodiments, the AI-based fraud deterrence model may be configured to generate the one or more fraud deterrence recommendations based in part on one or more user-initiated actions executed with respect to the fraudulent correspondence. In this regard, the correspondence fraud mitigation system may be configured to adapt to the actions of a user and generate fraud deterrence recommendations that are configured to mitigate an ongoing fraud event.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a correspondence fraud mitigation system.

FIG. 2 illustrates a schematic block diagram of example circuitry embodying a system device that may perform various operations in accordance with some example embodiments described herein.

FIG. 3 illustrates a schematic block diagram of example circuitry embodying a user device that may perform various operations in accordance with some example embodiments described herein.

FIG. 4 illustrates an example dataflow diagram for dynamically mitigating correspondence fraud in accordance with some example embodiments described herein.

FIG. 5 illustrates an example flowchart diagram for detecting correspondence inconsistencies in order to generate a set of fraud patterns in accordance with some example embodiments described herein.

FIG. 6 illustrates an example flowchart for determining user-initiated actions in order to generate fraud deterrence recommendations in accordance with some example embodiments described herein.

FIG. 7 illustrates an example user interface of a software application instance associated with a correspondence fraud mitigation system in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “user device” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

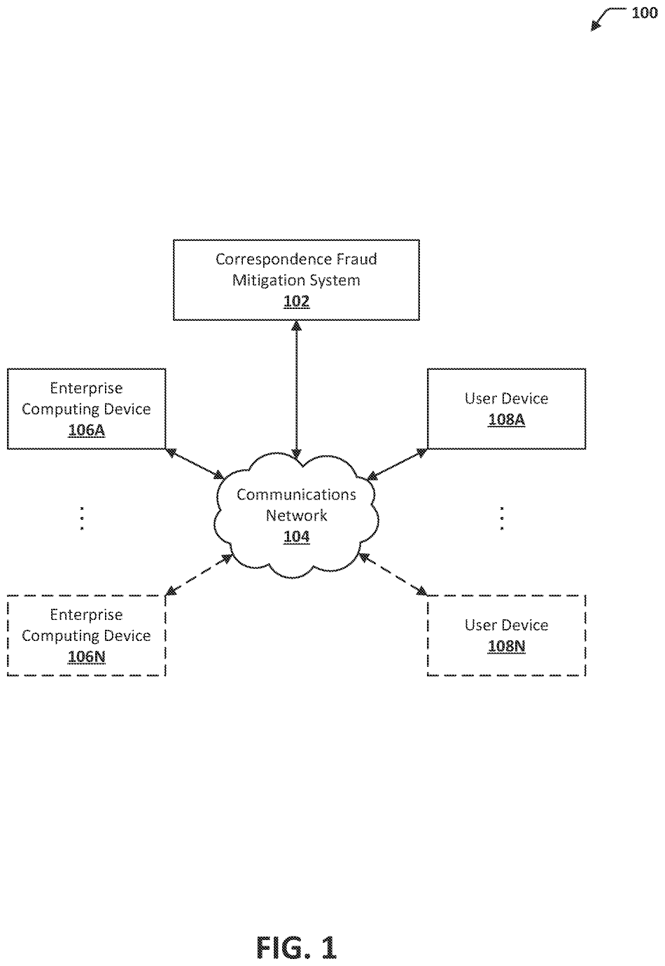

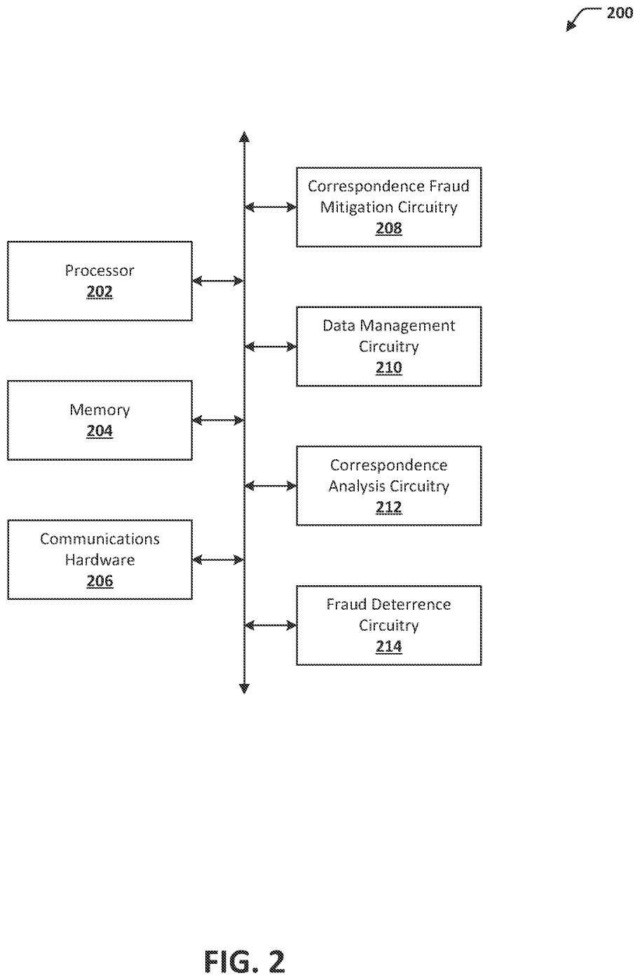

Example embodiments described herein may be implemented using any of a variety of computing devices or servers. To this end, FIG. 1 illustrates an example environment 100 within which various embodiments may operate. As illustrated, a correspondence fraud mitigation system 102 may receive and/or transmit information via communications network 104 (e.g., the Internet) with any number of other devices, such as one or more of enterprise computing devices 106A-106N and/or user devices 108A-108N. The correspondence fraud mitigation system 102 may be implemented as one or more computing devices or servers, which may be composed of a series of components. Particular components of the correspondence fraud mitigation system 102 are described in greater detail below with reference to apparatus 200 in connection with FIG. 2.

In various embodiments, the correspondence fraud mitigation system 102 may be associated with an enterprise (e.g., a financial institution, bank, and/or the like) and may be configured to manage various correspondence authentication processes for users associated with said enterprise. For example, the correspondence fraud mitigation system 102 may be configured to manage, execute, initiate, and/or otherwise facilitate one or more correspondence delivery verification processes, correspondence content data feature management processes, correspondence fraud mitigation processes, fraud deterrence recommendation generation processes, fraudulent correspondence alert transmission processes, enterprise data management processes, user login processes, user identity verification processes, and/or the like for a plurality of users associated with a respective enterprise. In one or more embodiments, the correspondence fraud mitigation system 102 may be configured to detect and/or mitigate correspondence fraud by receiving candidate correspondence from one or more user devices associated with the one or more users (e.g., enterprise computing devices 106A-106N, user devices 108A-108N, and/or the like) via the communications network 104. As will be described in further detail herein, the correspondence fraud mitigation system 102 may be configured to receive candidate correspondence in various formats and from various sources. As a non-limiting example, the candidate correspondence may be a digital representation of printed correspondence (e.g., correspondence received by the user in the mail), and the candidate correspondence may be generated based on imaging and/or scanning the printed correspondence via an imaging device (e.g., a rear-facing camera) associated with a user device (e.g., user device 108A) of the user. As another non-limiting example, the candidate correspondence may be digital correspondence (e.g., email, SMS message, etc.) received by a user device (e.g., user device 108A) associated with a respective user. As yet another non-limiting example, the candidate correspondence may be audio correspondence (e.g., an audio data transmission received by a user device (e.g., user device 108A)) such as a voicemail, voice message, audio recording, and/or the like.

In this regard, various users associated with an enterprise may interact with the correspondence fraud mitigation system 102 via a software application instance, where the software application instance may be configured to facilitate one or more of the various correspondence fraud mitigation processes described herein. In various embodiments, the software application instance associated with the correspondence fraud mitigation system 102 may be installed and/or downloaded to a user device (e.g., a user device 108A configured as a mobile device, laptop, and/or the like) and may present one or more user interface configurations to a respective user.

As such, the software application instance associated with the correspondence fraud mitigation system 102 may be configured to guide a user through the various steps of a correspondence fraud mitigation process. For example, the software application instance associated with the correspondence fraud mitigation system 102 may be configured to cause display of various interactive user interface elements to the user to facilitate the capture and/or reception of candidate correspondence from the user, and/or enable the user to manage one or more portions of user data (e.g., user profile data, user account data, and/or other user data). In such example embodiments, the software application instance may be configured to facilitate the imaging and/or scanning of various printed correspondence received by a user by employing an image capturing device (e.g., a rear-facing camera) of a user device (e.g., user device 108A) to image and/or scan the printed correspondence. Additionally, in various embodiments, the software application instance associated with the correspondence fraud mitigation system 102 may be configured to enable a user to access a software application framework related to a respective enterprise by, for example, granting (e.g., transmitting, enabling, toggling, configuring, etc.) one or more access permissions for a user device (e.g., a user device 108A) associated with the user, where the one or more access permissions enable the user device to access the software application framework associated with the enterprise.

In some embodiments, the correspondence fraud mitigation system 102 includes, embodies, and/or otherwise integrates with one or more of a correspondence analysis model and/or a fraud deterrence model configured to facilitate one or more of the various correspondence fraud mitigation operations described herein. In various embodiments, the correspondence analysis model and/or the fraud deterrence model may be configured to execute various machine learning (ML), machine vision (MV), AI, generative AI, natural language processing (NLP), and/or optical character recognition (OCR) techniques. For example, the correspondence analysis model may be configured to process and/or extract various correspondence content data features from candidate correspondence received by a user in order to execute one or more fraud mitigation techniques. In various embodiments, the correspondence analysis model and/or the fraud deterrence model may be a supervised or unsupervised model and may be configured as an artificial neural network (ANN), recurrent neural network (RNN), convolutional neural network (CNN), long short-term memory (LSTM) network, transformer model, rules-based model, or any other suitable deep learning model.

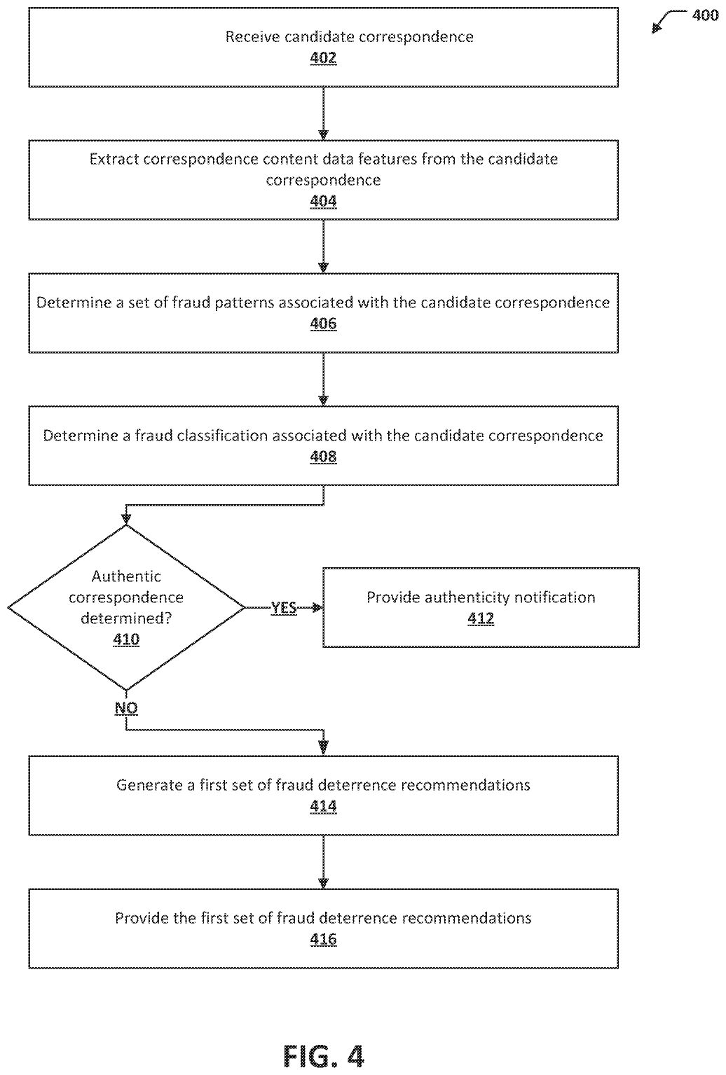

In some embodiments, the correspondence fraud mitigation system 102 may train (e.g., initially, periodically, iteratively, etc.) a supervised correspondence analysis model and/or a supervised fraud deterrence model using supervised training techniques (e.g., using labeled training data, classification, regression, etc.) described herein to perform one or more operations described in further detail in connection with FIGS. 4-6. In other embodiments, the correspondence fraud mitigation system 102 may train (e.g., initially, periodically, iteratively, etc.) an unsupervised correspondence analysis model and/or an unsupervised fraud deterrence model using unsupervised training techniques (e.g., using unlabeled training data, clustering, association, etc.) described herein to perform one or more operations described in further detail in connection with FIGS. 4-6. In this regard, the correspondence fraud mitigation system 102 may be configured to embody and/or integrate with one or more discrete AI models configured to perform specific tasks associated with the methods described herein.

In some embodiments, the correspondence analysis model may be trained using a correspondence training corpus. The correspondence training corpus may include a plurality of authentic correspondence from the enterprise and/or non-authentic correspondence received from a different entity. In embodiments where the correspondence analysis model is using a supervised learning technique, the plurality of correspondences that are labelled with an indication of whether they are authentic or non-authentic (e.g., fraudulent). Furthermore, the non-authentic correspondence may be labelled with an indication of a type of fraud pattern that corresponds to the fraudulent correspondence. In embodiments where the correspondence analysis model using an unsupervised learning technique, the plurality of correspondences are not labelled but the correspondence analysis model may employ any unsupervised learning techniques to train its parameters, such as clustering. Furthermore, in some embodiments, the correspondence analysis model may be refined through reinforcement learning. For example, a user may provide a training correspondence to the correspondence analysis model and the correspondence analysis model may output a fraud classification for the training correspondence to the user. The user may provide feedback (e.g., a confirmation that it correctly determined the fraud classification or an indication that the determined fraud classification was incorrect and/or a correction to the ground-truth fraud classification) to the correspondence analysis model regarding whether it correctly inferred the fraud classification for the training correspondence. In this way, the correspondence analysis model may further refine its parameters, resulting in a more accurate model.

For example, in various embodiments, a correspondence analysis model associated with the correspondence fraud mitigation system 102 may be configured to extract one or more correspondence content data features from candidate correspondence received from a user in order to execute various fraud mitigation operations. In this regard, the correspondence analysis model may be configured to determine a set of fraud patterns associated with a candidate correspondence based on the one or more correspondence content data features extracted from the candidate correspondence. The correspondence analysis model may also be configured to determine, based on the set of fraud patterns, a fraud classification associated with the candidate correspondence. Based in part on the fraud classification, the correspondence analysis model may determine whether the candidate correspondence is authentic and/or originated from an enterprise with which the user is associated or whether the candidate correspondence is indeed fraudulent.

In examples in which the candidate correspondence is determined to be fraudulent correspondence, the fraud classification associated with the fraudulent correspondence may be employed by a fraud deterrence model associated with the correspondence fraud mitigation system 102 to generate one or more fraud deterrence recommendations. The one or more fraud deterrence recommendations may be configured to mitigate one or more fraudulent correspondence tactics associated with the fraudulent correspondence. These and other operations executed by the correspondence analysis model and the fraud deterrence model will be described in greater detail herein below with reference to FIGS. 4-6.

In some embodiments, the correspondence fraud mitigation system 102 further includes a storage device that comprises a distinct component from other components of the correspondence fraud mitigation system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device may host the software executed to operate the correspondence fraud mitigation system 102. Additionally or alternatively, the storage device may store information relied upon during operation of the correspondence fraud mitigation system 102, such as various user data (e.g., user profile data, user account data, etc.), fraud pattern data, fraud classification data, AI model training data, AI model input data, AI model output data, enterprise data (e.g., product and/or service data, distribution data, logistical data, legal data, software application framework data, etc.), and/or the like configured in various data formats to be utilized by the correspondence fraud mitigation system 102. In addition, the storage device may store control signals, device characteristics, and/or access credentials enabling interaction between the correspondence fraud mitigation system 102 and/or one or more of the enterprise computing devices 106A-106N or user devices 108A-108N.

In various embodiments, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatuses

The correspondence fraud mitigation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-6. As illustrated in FIG. 2, the apparatus 200 may include processor 202, memory 204, communications hardware 206, correspondence fraud mitigation circuitry 208, data management circuitry 210, correspondence analysis circuitry 212, and/or fraud deterrence circuitry 214 each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises correspondence fraud mitigation circuitry 208. In some embodiments, the correspondence fraud mitigation circuitry 208 may be configured to facilitate the execution of one or more correspondence fraud mitigation operations for an enterprise associated with the correspondence fraud mitigation system 102. Additionally, the correspondence fraud mitigation circuitry 208 may utilize processor 202, memory 204, or any other hardware component included in the apparatus 200 (e.g., one or more cameras, mobile phone cameras, web cameras, automated teller machine (ATM) cameras, and/or the like) to perform these operations, as described in connection with FIGS. 4-6 below.

In various embodiments, the correspondence fraud mitigation circuitry 208 may be configured to receive one or more portions of image input data representative of printed candidate correspondence. In some examples, the image input data representative of the printed candidate correspondence may be captured by a user device (e.g., user device 108A, web camera, smartphone, and/or other user devices) associated with a user. In various examples, the image input data representative of the printed candidate correspondence may include one or more portions of still image data (e.g., pixels, contour lines, color gradients, contrast regions, etc.) and/or one or more portions of video data (e.g., video frames, pixels, contour lines, color gradients, contrast regions etc.) captured with respect to the text, images, branding, logos, icons, scannable imprints (e.g., quick response (QR) codes, barcodes, etc.), watermarks, and/or the like associated with the printed candidate correspondence.

The correspondence fraud mitigation circuitry 208 may further utilize the communications hardware 206 to gather data from, or transmit data to, a variety of sources (e.g., enterprise computing devices 106A-106N, user devices 108A-108N, social media networks, consumer banking servers, and/or any storage devices associated with the correspondence fraud mitigation system 102), and/or exchange data with a user. In some embodiments, the correspondence fraud mitigation circuitry 208 may work in conjunction with (e.g., may direct and/or otherwise manage) the data management circuitry 210, the correspondence analysis circuitry 212, and/or the fraud deterrence circuitry 214 in order to execute one or more of the methods described herein. For example, in some embodiments, the correspondence fraud mitigation circuitry 208 may integrate with and/or otherwise leverage the correspondence analysis circuitry 212 and/or the fraud deterrence circuitry 214 to employ a correspondence analysis model and/or fraud deterrence model respectively to execute the various methods and operations described herein.

Furthermore, in various embodiments, the correspondence fraud mitigation circuitry 208 may be configured to leverage the processor 202, the memory 204, and/or the communications hardware 206 to provide (e.g., generate, cause transmission of, and/or cause display of) a plurality of interactive user interface elements on a user interface associated with a software application instance associated with the correspondence fraud mitigation system 102 on a user device 108A. The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) designed to facilitate the capture of one or more portions of user input including, but not limited to, the capture of one or more portions of image data related to printed candidate correspondence received by a user. For example, the correspondence fraud mitigation circuitry 208 may be configured to leverage a plurality of interactive user interface elements associated with the software application instance to facilitate the imaging and/or scanning of various printed correspondence received by a user by controlling, based on an interaction with the interactive user interface elements, an image capturing device (e.g., a rear-facing camera) of a user device (e.g., user device 108A) to facilitate the imaging and/or scanning of the printed correspondence.

Furthermore, the correspondence fraud mitigation circuitry 208 may be configured to leverage a plurality of interactive user interface elements in order to communicate (e.g., display) that a respective candidate correspondence is indeed fraudulent correspondence. For example, the correspondence fraud mitigation circuitry 208 may be configured to cause display of one or more fraudulent correspondence alerts associated with the respective candidate correspondence on the user interface associated with the software application instance associated with the correspondence fraud mitigation system 102. Furthermore, the correspondence fraud mitigation circuitry 208 may be configured to cause display of one or more fraud deterrence recommendations generated by the fraud deterrence circuitry 214 based on a fraud classification associated with a respective candidate correspondence. In various examples, the one or more fraud deterrence recommendations may be associated with one or more interactive user interface elements configured to initiate execution of one or more actions associated with the one or more fraud deterrence recommendations.

In various embodiments, the correspondence fraud mitigation circuitry 208 may be configured to leverage the processor 202, the memory 204, and/or the communications hardware 206 to facilitate the real time or near-real time communication of a user with one or more components of the correspondence fraud mitigation system 102. For example, the correspondence fraud mitigation circuitry 208 may be configured to facilitate one or more virtual communications sessions between the user and a virtual assistant or so-called “chat-bot” that is configured to integrate with one or more AI models associated with the correspondence fraud mitigation system 102. In various embodiments, a virtual assistant integrated with a fraud deterrence model may be configured to communicate with a user (e.g., via a generative AI-based chat session, AI-generated audio communications, text-based prompts, etc.) to determine one or more user-initiated actions that have been executed with respect to candidate correspondence. Further details related to these, and other operations will be described in further detail herein below with reference to FIGS. 4-6.

In addition, the apparatus 200 further comprises data management circuitry 210 that may be configured to facilitate the management and/or utilization of various data associated with a respective enterprise by various components associated with the correspondence fraud mitigation system 102. The data management circuitry 210 may utilize processor 202, memory 204, or any other hardware component included in the apparatus 200 to perform these operations, as described in connection with FIGS. 4-6 below. The data management circuitry 210 may further utilize communications hardware 206 to gather data from a variety of sources (e.g., enterprise computing devices 106A-106N, user devices 108A-108N, and/or any storage devices associated with the correspondence fraud mitigation system 102), and/or exchange data with a user, and in some embodiments may utilize processor 202 and/or memory 204 to receive, retrieve, parse, process, store, update, delete, and/or otherwise manage one or more portions of enterprise data associated with a respective enterprise, and/or data related to one or more fraud patterns (e.g., known fraud patterns associated with known correspondence fraud tactics). In some embodiments, the data management circuitry 210 may work in conjunction with the correspondence fraud mitigation circuitry 208, the correspondence analysis circuitry 212, and/or the fraud deterrence circuitry 214 in order to execute one or more of the methods described herein.

In various embodiments, the data management circuitry 210 may be configured to manage one or more portions of ground-truth data associated with a respective enterprise in order to facilitate one or more correspondence fraud mitigation operations described herein. In various embodiments, the ground-truth data associated with an enterprise may comprise data related to one or more enterprise correspondence style rules (e.g., text formatting rules related to specific fonts, text emphasis, text decorations, text styles, etc.), correspondence tone (e.g., a professional tone, formal tone, informal tone, etc.), enterprise branding rules (e.g., requirements associated with logos, letterhead, icons, lexicon usage, etc.), enterprise product data (e.g., current product information, service information, promotion information, offer information, etc.), user data (e.g., user profile data, user account data, user identification data, etc.), user data obfuscation rules (e.g., rules for displaying PII, account information, credit card number information, etc.), correspondence delivery records (e.g., intended recipient data, originating correspondence source data, delivery timestamp data, expected arrival time data, etc.), domain knowledge data (e.g., financial domain data, technology domain data, business domain data, etc.), library of forms data (e.g., known enterprise form letters, known correspondence configurations, known fraudulent correspondence, known fraud patterns, etc.), and/or the like. In various embodiments, the ground-truth data managed by the data management circuitry 210 may be associated with, affiliated with, provided by, and/or otherwise managed by a third-party entity with which the enterprise is associated (e.g., a third-party research institution, domain oversight institution, enterprise competitor, and/or the like).

In addition, the apparatus 200 further comprises correspondence analysis circuitry 212 that may be configured to integrate with, embody, direct, and/or otherwise manage a correspondence analysis model associated with the correspondence fraud mitigation system 102. The correspondence analysis circuitry 212 may utilize processor 202, memory 204, or any other hardware component included in the apparatus 200 to perform these operations, as described in connection with FIGS. 4-6 below. The correspondence analysis circuitry 212 may further utilize communications hardware 206 to gather data from a variety of sources (e.g., enterprise computing devices 106A-106N, user devices 108A-108N, and/or any storage devices associated with the correspondence fraud mitigation system 102), and/or exchange data with a user, and in some embodiments may utilize processor 202 and/or memory 204 to determine whether correspondence received by a respective user is authentic and/or originated from an enterprise with which the user is associated, or whether the correspondence is fraudulent (e.g., designed to unlawfully obtain sensitive data, PII associated with a user, user account data, and/or valuable resources from the user and/or enterprise). In some embodiments, the correspondence analysis circuitry 212 may work in conjunction with the correspondence fraud mitigation circuitry 208, the data management circuitry 210, and/or the fraud deterrence circuitry 214 in order to execute one or more of the methods described herein.

In various embodiments, the correspondence analysis circuitry 212 may be configured to leverage a correspondence analysis model to extract one or more correspondence content data features from candidate correspondence received by a respective user (e.g., physically by mail or digitally by email, etc.). In various embodiments, the one or more correspondence content data features may include text data features (e.g., text string data, text content, words, phrases, substring data, etc.), text placement data features (e.g., paragraph styles, text placement and/or position relative to the overall document, etc.), text format data features (e.g., fonts, emphasis, styles, etc.), image data features (e.g., image placement, image content, etc.), scannable imprint features(e.g., QR codes, barcodes, watermarks, document identification codes, etc.). Additionally or alternatively, in embodiments in which the candidate correspondence is digital correspondence (e.g., email, SMS message, etc.), the one or more correspondence content data features extracted by the correspondence analysis model may further comprise hyperlink data features (e.g., web address data), interactive user interface element data features (e.g., HyperText Markup Language (HTML) data, control element data (e.g., buttons, sliders, etc.)), image metadata features, and/or the like.

Additionally or alternatively, in embodiments in which the candidate correspondence is audio correspondence (e.g., audio data received by a user device such as a voicemail, voice message, audio recording, and/or the like), the one or more correspondence content data features extracted by the correspondence analysis model may further comprise audio data features. In various embodiments, the audio data features may include one or more portions of acoustic feature data (e.g., timbre, pitch, fluctuation pattern data), valence data (e.g., whether a portion of the audio input data is related to a positive or negative emotion), arousal data (e.g., how excited or apathetic a user may be), dominance (e.g., how dominant or submissive a user may be), intensity data (e.g., volume data, gain data), intonation data, speech rate data, mel-frequency cepstral coefficient (MFCC) data, and/or the like. In this regard, in some embodiments, the correspondence fraud analysis model may be configured to determine, based in part on the audio data features associated with the audio correspondence, various fraud patterns associated with audio correspondence in order mitigate audio correspondence fraud. Additionally or alternatively, the correspondence analysis model may be configured to determine whether the audio correspondence has been artificially generated (e.g., audio data generated by an AI model to impersonate an individual, such as a “deepfake”).

In various embodiments, the correspondence analysis circuitry 212 may be configured to leverage the correspondence analysis model to determine a correspondence content data feature type for a respective correspondence content data feature. In such embodiments, the correspondence content data feature type may be indicative of the types of correspondence content data features comprised within the candidate correspondence. A correspondence content data feature type may be used to determine a respective evaluation routine to be employed with respect to the correspondence content data features, where the evaluation routine may be configured to determine one or more correspondence faults associated with the candidate correspondence. Some example evaluation routines may include a hyperlink evaluation routine, HTML element evaluation routine, image metadata evaluation routine, page script evaluation routine, source code evaluation routine, and/or correspondence source address evaluation routine.

The correspondence analysis circuitry 212 may be configured to leverage the correspondence analysis model to detect, based on one or more extracted correspondence content data features, a set of fraud patterns associated with the candidate correspondence. In various embodiments, the set of fraud patterns may be known patterns, presentations, and/or organizations of text, images, audio, and/or various correspondence content data features common to various types of fraudulent correspondence. For example, a respective fraud pattern may be associated with a commonly detected text format, word choice, and/or language error (e.g., typographical error, grammatical error, etc.) associated with various fraudulent correspondence. Additionally or alternatively, a respective fraud pattern may be associated with commonly detected correspondence content data features including, but not limited to, a particular tone (e.g., urgent tone), a particular level of detail (e.g., vague details intended to befuddle a user), a particular set of instructions (e.g., instructions to respond to the correspondence, provide information, etc.), set of “required actions” (e.g., indicating a user must take specific action or face consequences such as losing access to an account, termination of service, etc.), and/or PII solicitations. Additionally or alternatively, in examples in which the candidate correspondence is audio correspondence, a respective fraud pattern may be associated with a particular tone (e.g., urgent tone), a particular set of audio data features (e.g., acoustic features such as timbre, pitch, fluctuation patterns, etc.), a known AI-generated voice, a known manner of speaking (e.g., either by a human and/or related to an AI-generated voice and/or AI-generated speech), and/or the like.

For example, a respective fraud pattern may be associated with a false sense of urgency that implies to a respective user that the user must act quickly to address whatever issues are present in the candidate correspondence (e.g., fraudulent correspondence that claims a user's account has been hacked or sensitive information has been leaked and that the user must act immediately to address the issue). Furthermore, in some examples, the one or more fraud patterns may be associated with a respective fraud classification such that identification of the one or more fraud patterns may indicate the particular type of fraud classification associated with a candidate correspondence.

In some embodiments, the correspondence analysis circuitry 212 may be configured to leverage the correspondence analysis model to determine a set of fraud patterns based in part on one or more correspondence faults associated with the candidate correspondence. In this regard, the correspondence analysis model may be configured to generate, based on one or more extracted correspondence content data features, a set of correspondence faults comprising one or more correspondence faults associated with the candidate correspondence. In various examples, the set of correspondence faults may comprise one or more language errors including, but not limited to, typographical errors (e.g., spelling errors, spurious character errors, etc.), missing word errors, grammatical errors, language use errors, and/or the like. Additionally or alternatively, the set of correspondence faults may comprise one or more correspondence inconsistencies that contradict one or more portions of ground-truth data related to one or more enterprise correspondence style rules, correspondence tones, enterprise branding rules, enterprise product data, user data, user data obfuscation rules, correspondence delivery records, domain knowledge data, library of forms data, and/or the like associated with a respective enterprise purported to have transmitted (e.g., delivered) the candidate correspondence.

Additionally, the correspondence analysis circuitry 212 may be configured to leverage the correspondence analysis model to determine, based in part on a set of fraud patterns, a fraud classification associated with the candidate correspondence. Some examples of fraud classifications include impersonation fraud (e.g., enterprise impersonation, individual impersonation, etc.), phishing fraud (e.g., correspondence configured to solicit user data), credit card fraud, investment fraud, bank fraud, mortgage fraud, identify theft, extortion, intimidation, and/or the like. Additionally, in some examples, the correspondence analysis model may determine that a fraud classification associated with the candidate correspondence is an authentic classification (e.g., an authentic correspondence and/or communication transmitted from a respective enterprise to an intended user). In this regard, the correspondence analysis circuitry 212 may be configured to leverage the correspondence analysis model to determine, based on a fraud classification associated with a respective candidate correspondence, whether the candidate correspondence originated from an enterprise with which the user is associated. These and other operations associated with the correspondence analysis circuitry 212 will be described in further detail herein below with reference to FIGS. 4-6.

In addition, the apparatus 200 further comprises fraud deterrence circuitry 214 that may be configured to integrate with, embody, direct, and/or otherwise manage a fraud deterrence model associated with the correspondence fraud mitigation system 102. The fraud deterrence circuitry 214 may utilize processor 202, memory 204, or any other hardware component included in the apparatus 200 to perform these operations, as described in connection with FIGS. 4-6 below. The fraud deterrence circuitry 214 may further utilize communications hardware 206 to gather data from a variety of sources (e.g., enterprise computing devices 106A-106N, user devices 108A-108N, and/or any storage devices associated with the correspondence fraud mitigation system 102), and/or exchange data with a user, and in some embodiments may utilize processor 202 and/or memory 204 to generate one or more fraud deterrence recommendations. In some embodiments, the fraud deterrence circuitry 214 may work in conjunction with the correspondence fraud mitigation circuitry 208, the data management circuitry 210, and/or the correspondence analysis circuitry 212 in order to execute one or more of the methods described herein.

In various embodiments, the fraud deterrence circuitry 214 may be configured to leverage a fraud deterrence model to generate one or more fraud deterrence recommendations. The one or more fraud deterrence recommendations may be configured to mitigate one or more detected fraud tactics associated with a candidate correspondence that had been classified as fraudulent correspondence. In some embodiments, the one or more fraud deterrence recommendations may comprise one or more actionable recommendations for mitigating one or more fraud tactics associated with fraudulent correspondence. Some examples of fraud deterrence recommendations may include recommendations to report the correspondence to an information security team, delete the correspondence, abstain from clicking on hyperlinks associated with the correspondence, abstain from providing PII, change one or more passwords, enable two-factor authentication, check for unauthorized account activity, cease communication with an untrusted group or untrusted individual associated with the correspondence, initiate communication with a trusted individual or communication channel (e.g., via a software application instance associated with the correspondence fraud mitigation system 102, via a publicized telephone number available on an authentic enterprise website, etc.), freeze a respective user's credit, contact local authorities (e.g., law enforcement authorities, municipal authorities, etc.), document any details related to an interaction of a user and an untrusted group and/or untrusted individual, and/or the like.

In various embodiments, the fraud deterrence circuitry 214 may be configured to leverage the fraud deterrence model to automatically execute one or more actions associated with the one or more fraud deterrence recommendations generated based on a particular fraudulent correspondence. For example, the fraud deterrence model may automatically cause the lockdown of a user account, cause transmission of one or more alerts associated with the fraudulent correspondence to an information security team associated with the enterprise, cause enabling of two-factor authentication for a user device (e.g., user device 108A) associated with the user, and/or the like. In this regard, the fraud deterrence circuitry 214 may be configured to leverage the fraud deterrence model to determine a fraud severity level for the respective candidate correspondence and, based in part on the determined fraud severity level, initiate the automatic execution of one or more actions associated with the one or more fraud deterrence recommendations.

Additionally, in various embodiments, the fraud deterrence circuitry 214 may be configured to leverage the fraud deterrence model to determine one or more user-initiated actions executed with respect to a candidate correspondence, where the one or more user-initiated actions are characterized by an engagement of the user with the candidate correspondence. Some examples of a user-initiated action may include clicking on a hyperlink associated with the candidate correspondence (e.g., a link comprised within an email), providing PII or other user data to an untrusted group and/or individual that sent the candidate correspondence, responding to the candidate correspondence (e.g., responding to one or more instructions in printed correspondence), and/or any other engagement with the candidate correspondence by the user.

For example, the fraud deterrence circuitry 214 may be configured to leverage the fraud deterrence model to analyze digital candidate correspondence (e.g., an email) that has been engaged by a user to determine whether one or more hyperlinks and/or buttons have been interacted with. As a non-limiting example, the fraud deterrence model may be configured to determine based on one or more portions of source code (e.g., one or more portions of HTML code, JavaScript code, etc.) associated with the digital correspondence that one or more hyperlinks and/or buttons have been interacted with (e.g., clicked on). Additionally or alternatively, the fraud deterrence model may be configured to access user device history (e.g., web browser history, software application history, etc.) associated with a user device (e.g., user device 108A) associated with a respective user to determine whether the digital candidate correspondence has been interacted with (e.g., one or more web addresses have been accessed via the digital candidate correspondence, one or more scripts and/or portion of executable program code have been executed or initiated via the digital candidate correspondence, and/or the like).

Furthermore, the fraud deterrence model may be configured to determine a risk level for each user-initiated action of the one or more user-initiated actions and generate, based on the risk levels, one or more fraud deterrence recommendations. In this regard, the fraud deterrence model may be configured to mitigate one or more risks, problems, and/or issues caused by one or more interactions of the user with the candidate correspondence. These and other operations associated with the fraud deterrence circuitry 214 will be described in further detail herein below with reference to FIGS. 4-6.

Although components 202-214 are described in part using functional language, it will be understood that the particular implementations necessarily include the use of particular hardware. It should also be understood that certain of these components 202-214 may include similar or common hardware. For example, the correspondence fraud mitigation circuitry 208, the data management circuitry 210, the correspondence analysis circuitry 212, and/or the fraud deterrence circuitry 214 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the correspondence fraud mitigation circuitry 208, the data management circuitry 210, the correspondence analysis circuitry 212, and/or the fraud deterrence circuitry 214 may leverage processor 202, memory 204, and/or communications hardware 206 as described above, it will be understood that any of the correspondence fraud mitigation circuitry 208, the data management circuitry 210, the correspondence analysis circuitry 212, and/or the fraud deterrence circuitry 214 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the correspondence fraud mitigation circuitry 208, the data management circuitry 210, the correspondence analysis circuitry 212, and/or the fraud deterrence circuitry 214 comprise particular machinery designed for performing the functions described herein in connection with such elements of apparatus 200.

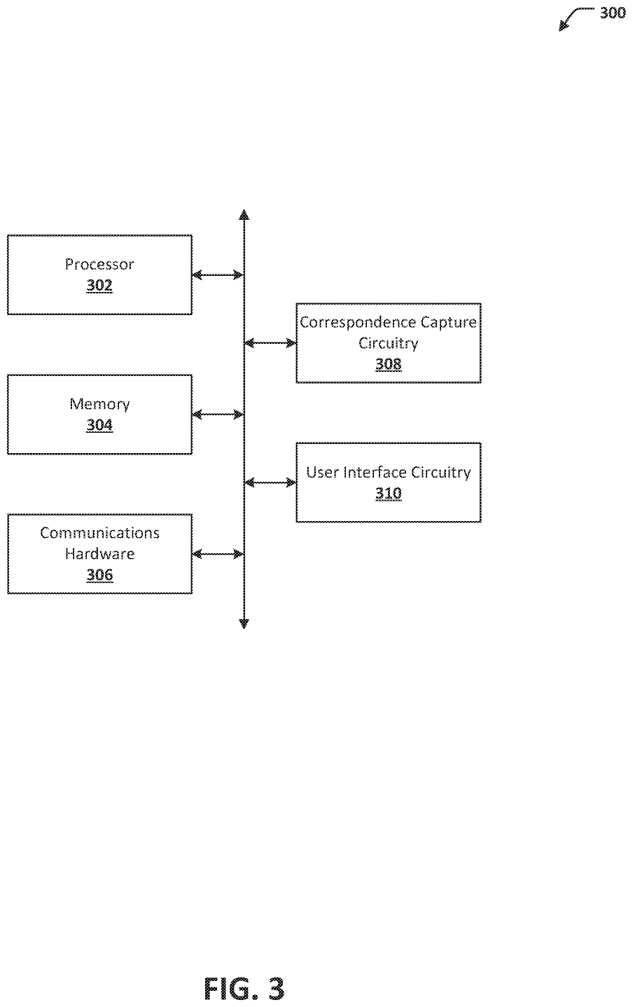

As illustrated in FIG. 3, an apparatus 300 is shown that represents an example enterprise computing device (e.g., any of enterprise computing devices 106A-106N) or an example user device (e.g., any of user devices 108A-108N). The apparatus 300 includes processor 302, memory 304, and communications hardware 306, each of which is configured to be similar to the similarly named components described above in connection with FIG. 2. Additionally, the apparatus 300 may also include correspondence capture circuitry 308, and/or user interface circuitry 310, each of which may be configured to facilitate the execution of the various methods described herein. For example, the correspondence capture circuitry 308, and/or the user interface circuitry 310 may be configured to generate, capture, aggregate, process, and/or otherwise manage one or more portions of candidate correspondence data received by a user and transmit the candidate correspondence data to the correspondence fraud mitigation system 102 in order to facilitate the execution of one or more of the methods described herein.

The correspondence capture circuitry 308 includes hardware components designed for capturing one or more portions of data related to candidate correspondence received by a respective user and/or causing transmission of the one or more portions of data related to candidate correspondence to the correspondence fraud mitigation system 102. In some embodiments, the correspondence capture circuitry 308 may utilize processor 302, memory 304, or any other hardware component included in the apparatus 300 to perform the operations described in connection with FIGS. 4-6 below. The correspondence capture circuitry 308 may comprise, embody, integrate with and/or otherwise control one or more image capture devices associated with a computing device (e.g., user device 108A, enterprise computing device 106A, etc.) such as, for example, one or more cameras (e.g., front- and/or rear-facing cameras, web cameras, ATM cameras, etc.) associated with one or more respective fields of view configured to capture image data and/or video data.

For example, the correspondence capture circuitry 308 may be configured to capture and/or scan image data representative of candidate correspondence received by a user by mail, hand-delivery, and/or the like. In some embodiments, the apparatus 300 may be configured as a user device (e.g., user device 108A) and the correspondence capture circuitry 308 may be configured to capture and/or scan image data representative of the candidate correspondence based on one or more interactions with a software application instance associated with the correspondence fraud mitigation system 102. For example, as described herein, a software application instance associated with the correspondence fraud mitigation system 102 may be configured to guide a user through one or more operations related to imaging and/or scanning data representative of the candidate correspondence via the various hardware components of the correspondence capture circuitry 308 associated with the user device (e.g., one or more cameras associated with a user device 108A).

As a non-limiting example, the correspondence capture circuitry 308 may be configured to facilitate the alignment of printed correspondence within the field-of-view of a camera (e.g., a rear-facing camera) embodied by a user device (e.g., user device 108A). For instance, the correspondence capture circuitry 308 may be configured to cause display of a digital representation of a frame, border, outline, and/or the like via the user interface of a software application instance associated with the correspondence fraud mitigation system 102 on an electronic display (e.g., touchscreen, liquid crystal display (LCD), etc.) of the user device (e.g., user device 108A). For example, in such embodiments, the correspondence capture circuitry 308 may overlay a digital representation of a frame atop a real time (or near-real time) video data feed being captured via the rear-facing camera of the user device, where the video data feed being captured is utilized to align the printed correspondence within the digital representation of the frame. Once aligned, the correspondence capture circuitry 308 may be configured to record, scan, capture, and/or otherwise record image data associated with the printed correspondence and cause transmission of the recorded image data to the correspondence fraud mitigation system 102 for processing (e.g., by the correspondence analysis circuitry 212).

In addition, the apparatus 300 may also include the user interface circuitry 310, which includes hardware components designed for receiving user inputs and/or rendering virtual graphics outputs. The user interface circuitry 310 may utilize processor 302, memory 304, or any other hardware component included in, or integrated with, the apparatus 300 to perform these operations, as described in connection with FIGS. 4-6 below. The user interface circuitry 310 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The user interface circuitry 310 may comprise one or more of a keyboard, pointing device, touchscreen, microphone with speech recognition interface, one or more cameras, and/or one or more other input devices capable of receiving various different user inputs. In addition, the user interface circuitry 310 may comprise a display device including one or more of a screen with graphical user interface (GUI), speaker, light-emitting diode (LED) display, organic LED (OLED) display, LCD display, touchscreen, haptic technology device, and/or other output device capable of rendering information to a user. In this regard, the user interface circuitry 310 may be configured to facilitate the capture, generation, reception, transmission, and/or management of one or more portions of user input data, candidate correspondence data, and/or the like to be used for one or more correspondence fraud mitigation operations executed by the correspondence fraud mitigation system 102.

Additionally, the user interface circuitry 310 may utilize processor 302, memory 304, or any other hardware component included in, or integrated with, the apparatus 300 to run, host, configure, and/or otherwise execute one or more operations, instructions, and/or commands related to a software application instance associated with the correspondence fraud mitigation system 102. For example, the user interface circuitry 310 may be configured allow a user to interact with the correspondence fraud mitigation system 102 via the software application instance in order to facilitate one or more correspondence fraud mitigation operations and/or any of the other methods described herein.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 4-6, example flowcharts are illustrated that contain example operations implemented by example embodiments described herein. The operations illustrated in FIGS. 4-6 may, for example, be performed by a system device (e.g., server, etc.) of the correspondence fraud mitigation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, correspondence fraud mitigation circuitry 208, data management circuitry 210, correspondence analysis circuitry 212, fraud deterrence circuitry 214, and/or any combination thereof. It will be understood that user interaction with the correspondence fraud mitigation system 102 may occur directly via communications hardware 206, or may instead be facilitated by a separate computing device (e.g., any of enterprise computing devices 106A-106N, and/or user devices 108A-108N shown in FIG. 1, which may in turn be embodied by an apparatus 300, which is shown and described in connection with FIG. 3), and which may have similar or equivalent physical componentry facilitating such user interaction.

Turning first to FIG. 4, flowchart 400 illustrates example operations for dynamically mitigating correspondence fraud.

As shown by operation 402, the apparatus 200 may include means, such as processor 202, memory 204, communications hardware 206, correspondence fraud mitigation circuitry 208, and/or the like for receiving candidate correspondence associated with a user. As described herein, in some examples, candidate correspondence may be digital correspondence (e.g., email, SMS messages, notifications, etc.) received by a user via a user device (e.g., any one of user devices 108A-108N). Such digital candidate correspondence may be received by the user device by way of any suitable network communication platform such as an email platform, phone network, and/or any software-based communications platform capable of integrating with the user device associated with the user.

In various embodiments, the communications hardware 206 may be configured to receive such digital candidate correspondence associated with the user via the communications network 104. For instance, in some embodiments, a software application instance associated with the correspondence fraud mitigation system 102 running on a user device (e.g., user device 108A) may be configured to facilitate the submission of one or more digital candidate correspondences configured as an email, SMS message, notification, and/or the like. As a non-limiting example, a user may receive digital correspondence (e.g., an email) that appears to be from an enterprise with which the user is associated and may subsequently submit the digital correspondence to the correspondence fraud mitigation system 102 for authentication via the software application instance. In this regard, the correspondence fraud mitigation system 102 may be configured to facilitate the submission and/or reception of candidate correspondence that is configured in various data formats including, but not limited to, email file formats, SMS message formats, portable document format (PDF) file format, word processing software document formats, image formats, source code file formats, video file formats, audio file formats, and/or any appropriate data format used to configure various types of correspondence.

Additionally or alternatively, as described herein, candidate correspondence may be printed correspondence directed to the user that is received in the mail or hand-delivered to the user directly. Some examples of such candidate correspondence may include letters, direct mail (e.g., flyers, mailers, etc.), memos, brochures, reports, advertisements, postcards, notices, directives, communications, and/or the like that are printed and/or hand-written and directed to (e.g., addressed to) the user. In this regard, the correspondence fraud mitigation system 102 may be configured to facilitate the generation of candidate correspondence that is a digital representation of one or more printed correspondences. For example, in various embodiments and as described herein, the correspondence fraud mitigation circuitry 208 may be configured to leverage a plurality of interactive user interface elements associated with a software application instance associated with the correspondence fraud mitigation system 102 to facilitate the imaging and/or scanning of various printed correspondence received by a user by controlling, based on an interaction with the interactive user interface elements, an image capturing device (e.g., a rear-facing camera) of a user device (e.g., any one of user devices 108A-108N) to facilitate the imaging and/or scanning of the printed correspondence.

As shown by operation 404, the apparatus 200 may include means, such as processor 202, memory 204, correspondence analysis circuitry 212, and/or the like for extracting one or more correspondence content data features from the candidate correspondence. As described herein, correspondence content data features may include text data features (e.g., text string data, text content, words, phrases, substring data, etc.), text placement data features (e.g., paragraph styles, text placement and/or position relative to the overall document, etc.), text format data features (e.g., fonts, emphasis, styles, etc.), image data features (e.g., image placement, image content, etc.), scannable imprint features (e.g., QR codes, barcodes, watermarks, identification codes, etc.). Additionally or alternatively, in embodiments in which the candidate correspondence is digital correspondence (e.g., email, SMS message, etc.), the correspondence content data features extracted by the correspondence analysis model may further comprise hyperlink data features (e.g., web address data, webpage content data, etc.), interactive user interface element data features (e.g., HTML data, control element data (e.g., buttons, sliders, etc.)), image metadata, and/or the like.

In various embodiments, the correspondence analysis circuitry 212 may be configured to leverage a correspondence analysis model to process and/or extract various correspondence content data features from candidate correspondence. For example, the correspondence analysis model may be configured to employ one or more NLP, OCR, and/or image recognition techniques to extract one or more correspondence content data features from candidate correspondence associated with a respective user. In circumstances in which the candidate correspondence is directed to a respective user, the correspondence analysis circuitry 212 may be configured to leverage the correspondence analysis model to detect, extract, evaluate, and/or otherwise process user data (e.g., PII, user account data, etc.) comprised within the correspondence content data features (e.g., text data features). As a non-limiting example, the correspondence analysis model may be configured to detect a 16-digit user account number associated with the user within the correspondence content data features, and that the last five digits of the user account number have been preceded by eleven placeholder characters (e.g., “***********12345”).

Additionally or alternatively, the correspondence analysis circuitry 212 may be configured to leverage the correspondence analysis model to detect, extract, evaluate, and/or otherwise process enterprise data comprised within the one or more correspondence content data features (e.g., text data features). As a non-limiting example, the correspondence analysis model may be configured to determine that the candidate correspondence comprises information that is allegedly related to one or more offers, products, and/or services associated with an enterprise. For example, the candidate correspondence may comprise a “special offer” directed towards a respective user based on the merits of the user, a type of account or service the user has subscribed to in the past, and/or because the user has “earned” said special offer by way of their behavior. As another example, the candidate correspondence may comprise information related to an available product or service offered by the enterprise for which the user may take advantage if the user responds to the candidate correspondence in a correct manner.

As another non-limiting example, the correspondence analysis model may be configured to determine that the candidate correspondence comprises one or more instructions, suggested actions, required actions, recommendations, and/or calls-to-action that an enterprise has allegedly advised a respective user to execute. For example, the candidate correspondence may inform the user that an adverse situation has occurred (e.g., a situation in which the user has allegedly made a mistake (e.g., overdrawn a bank account), a situation in which sensitive data associated with the user has been exploited (e.g., a user account has been hacked, a credit card number has been use without authorization), and/or the like), and that the user must take immediate action to remedy the adverse situation.

As shown by operation 406, the apparatus 200 may include means, such as processor 202, memory 204, data management circuitry 210, correspondence analysis circuitry 212, and/or the like for determining, based on the one or more correspondence content data features, a set of fraud patterns associated with the candidate correspondence. For example, the correspondence analysis circuitry 212 may be configured to leverage the correspondence analysis model to parse, analyze, evaluate, and/or otherwise process the one or more correspondence content data features in order to detect the set of fraud patterns comprised in the candidate correspondence. As described herein, the set of fraud patterns may be known patterns, presentations, and/or organizations of text, images, and/or various correspondence content data features common to various types of fraudulent correspondence. For example, a respective fraud pattern may be associated with a commonly detected text format, word choice, and/or language error associated with various fraudulent correspondence. Additionally or alternatively, a respective fraud pattern may be associated with commonly detected features including, but not limited to, a particular tone (e.g., an urgent tone), a particular level of detail (e.g., vague details intended to befuddle a user), a particular set of instructions (e.g., instructions to respond to the correspondence, provide information, etc.), set of required actions (e.g., indicating a user must take specific action or face consequences such as losing access to an account, termination of service, etc.), and/or PII solicitations.

In various examples, the correspondence analysis circuitry 212 may be configured to leverage the correspondence analysis model to determine a set of fraud patterns based in part on one or more correspondence faults associated with the candidate correspondence. In various embodiments, a set of correspondence faults may comprise one or more language errors including, but not limited to, typographical errors (e.g., spelling errors, spurious character errors, etc.), missing word errors, grammatical errors, language use errors, and/or the like. Additionally or alternatively, the correspondence analysis circuitry 212 may be configured to work in conjunction with the data management circuitry 210 to determine a set of fraud patterns based in part on one or more correspondence inconsistencies detected in the candidate correspondence.

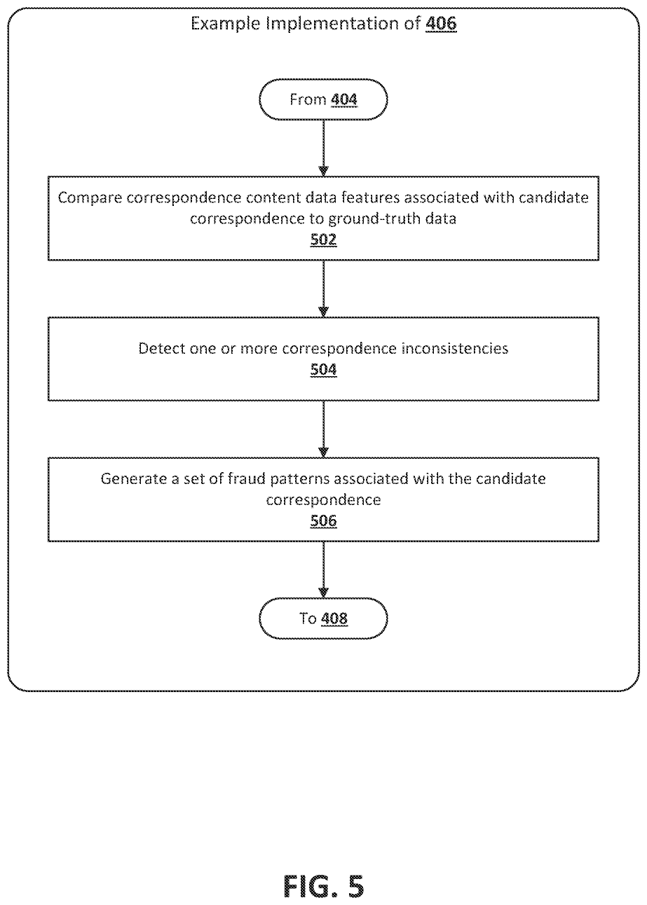

In various embodiments, the one or more correspondence inconsistencies may be errors that contradict one or more portions of ground-truth data related to one or more enterprise correspondence style rules (e.g., text formatting rules related to specific fonts, text emphasis, text decorations, text styles, etc.), correspondence tone (e.g., a professional tone, formal tone, informal tone, etc.), enterprise branding rules (e.g., requirements associated with logos, letterhead, icons, lexicon usage, etc.), enterprise product data (e.g., current product information, service information, promotion information, offer information, etc.), user data (e.g., user profile data, user account data, user identification data, etc.), user data obfuscation rules (e.g., rules for displaying PII, account information, credit card number information, etc.), correspondence delivery records (e.g., intended recipient data, originating correspondence source data, delivery timestamp data, expected arrival time data, etc.), domain knowledge data (e.g., financial domain data, technology domain data, business domain data, etc.), library of forms data (e.g., known enterprise form letters, known correspondence configurations, known fraudulent correspondence, known fraud patterns, known fraud patterns, etc.), and/or the like. Further details related to the execution of operation 406 with regard to correspondence inconsistencies will be described herein below with reference to FIG. 5.

In some embodiments, generating the set of correspondence faults associated with candidate correspondence further comprises executing one or more evaluation routines. As described herein, the one or more evaluation routines may be executed by the correspondence analysis model in response to determining one or more correspondence content data feature types associated with one or more respective correspondence content data features associated with the candidate correspondence. For example, the correspondence analysis circuitry 212 may be configured to leverage the correspondence analysis model to execute one or more of a hyperlink evaluation routine, HTML element evaluation routine, image metadata evaluation routine, page script evaluation routine, source code evaluation routine, and/or correspondence source address evaluation routine with respect to the candidate correspondence. As a non-limiting example, in a scenario in which the candidate correspondence is digital correspondence (e.g., email), the correspondence analysis model may be configured to parse, analyze, evaluate, and/or otherwise process embedded data (e.g., HTML data, image metadata, etc.) associated with the candidate correspondence in order to detect one or more fraud patterns, correspondence faults, and/or various fraud tactics associated with the candidate correspondence.

Furthermore, in various examples, the correspondence analysis circuitry 212 may be configured to work in conjunction with the data management circuitry 210 to leverage the correspondence analysis model to compare a set of correspondence faults to a set of known fraud patterns stored in a storage device associated with the correspondence fraud mitigation system 102. One or more of the known fraud patterns in the set of known fraud patterns may be associated with a common occurrence, recurrence, and/or instance of a particular correspondence fault and/or particular type of correspondence fault. As such, the correspondence analysis model may be configured to generate the set of fraud patterns based on comparing the set of correspondence faults to the set of known fraud patterns. In this regard, in some embodiments, the set of fraud patterns may be a subset of the set of known fraud patterns.

As shown by operation 408, the apparatus 200 may include means, such as processor 202, memory 204, correspondence fraud mitigation circuitry 208, correspondence analysis circuitry 212, and/or the like for determining a fraud classification associated with the candidate correspondence. For example, the correspondence analysis circuitry 212 may be configured to leverage the correspondence analysis model to determine a fraud classification for the candidate correspondence based at least in part on the set of fraud patterns. As described herein, the correspondence fraud mitigation system 102 may define any suitable number of fraud classifications to classify various candidate correspondence. Some examples of fraud classifications include impersonation fraud (e.g., enterprise impersonation, individual impersonation, etc.), phishing fraud (e.g., correspondence configured to solicit user data), credit card fraud, investment fraud, bank fraud, mortgage fraud, identify theft, extortion, intimidation, authentic, and/or the like. Furthermore, the correspondence analysis circuitry 212 may be configured to leverage the correspondence analysis model to determine, based on a fraud classification associated with a respective candidate correspondence, whether the candidate correspondence originated from an enterprise with which the user is associated.

In some embodiments, the correspondence analysis circuitry 212 may be configured to leverage the correspondence analysis model to determine a fraud classification for the candidate correspondence based in part on a classification probability associated with the candidate correspondence. In this regard, the correspondence analysis circuitry 212 may be configured to leverage the correspondence analysis model to generate a fraud classification probability associated with the candidate correspondence and a respective known fraud classification based at least in part on a comparison of the set of fraud patterns associated with the candidate correspondence with a set of known fraud patterns associated with the respective known fraud classification.

In various examples, the correspondence analysis model may be configured to generate one or more classification probabilities associated with the candidate correspondence and each fraud classification of a plurality of fraud classifications. In various embodiments, the fraud classification probability associated with the candidate correspondence may be any numerical value within a predefined numerical range (e.g., a number between zero (0) and one (1)) and may indicate a probability that a respective candidate correspondence corresponds to a known fraud classification. As such, the correspondence analysis circuitry 212 may be configured to leverage the correspondence analysis model to determine, based on an evaluation of one or more classification probabilities, a fraud classification for the respective candidate correspondence.

In this regard, the correspondence analysis model may be configured to determine if a fraud classification probability (e.g., a numerical value or the like) satisfies a respective fraud classification threshold (e.g., a numerical value or the like). The fraud classification probability may satisfy the respective fraud classification threshold if the fraud classification probability is greater than or equal to the respective fraud classification threshold (e.g., to within an error value of ±1%, ±5%, or any other number). In other examples, the fraud classification probability (e.g., a numerical value or the like) may satisfy the respective fraud classification threshold (e.g., a numerical value or the like) if the fraud classification probability is less than or equal to the respective fraud classification threshold (e.g., to within an error value of ±1%, ±5%, or any other number).

As shown by operation 410, the apparatus 200 may include means, such as processor 202, memory 204, fraud deterrence circuitry 214, and/or the like for determining whether the fraud classification is indicative of an authentic correspondence.

In an instance in which the fraud classification is indicative of an authentic correspondence, the process proceeds to operation 412. As shown by operation 412, the apparatus 200 may include means, such as processor 202, memory 204, communications hardware 206, correspondence fraud mitigation circuitry 208, and/or the like for providing an authenticity notification. In various embodiments, if the correspondence analysis circuitry 212 (e.g., in conjunction with the correspondence analysis model) determines that the candidate correspondence is authentic and/or did originate from the enterprise (e.g., has been classified as authentic), the correspondence fraud mitigation circuitry 208 may be configured to notify a respective user that the candidate correspondence is safe. In particular, the correspondence fraud mitigation circuitry 208 may be configured to generate and provide an authenticity notification to a user via the communications hardware 206. The authenticity notification may be indicative that the provided correspondence is authentic and can be trusted by the user. Thus, the user may safely proceed to interact or otherwise engage with the correspondence. The authenticity notification may be provided as one or more notifications, alerts, banners, messages, and/or the like to a user device (e.g., user device 108A) associated with the user. The one or more notifications, alerts, banners, messages, and/or the like may be configured to inform the user that the candidate correspondence is authentic and/or may be engaged with (e.g., responded to) safely.

In an instance in which the fraud classification is indicative of inauthentic correspondence, the process proceeds to operation 414. As shown by operation 414, the apparatus 200 may include means, such as processor 202, memory 204, fraud deterrence circuitry 214, and/or the like for generating a first set of fraud deterrence recommendations. For example, the fraud deterrence circuitry 214 may be configured to generate at least a first set of fraud deterrence recommendations based on a fraud classification associated with candidate correspondence that has been determined to be fraudulent correspondence (e.g. by the correspondence analysis model). As described herein, the one or more fraud deterrence recommendations may be configured to mitigate one or more detected fraud tactics associated with the fraudulent correspondence (e.g., tactics to elicit an engagement with and/or response to the correspondence by the user who received the correspondence).

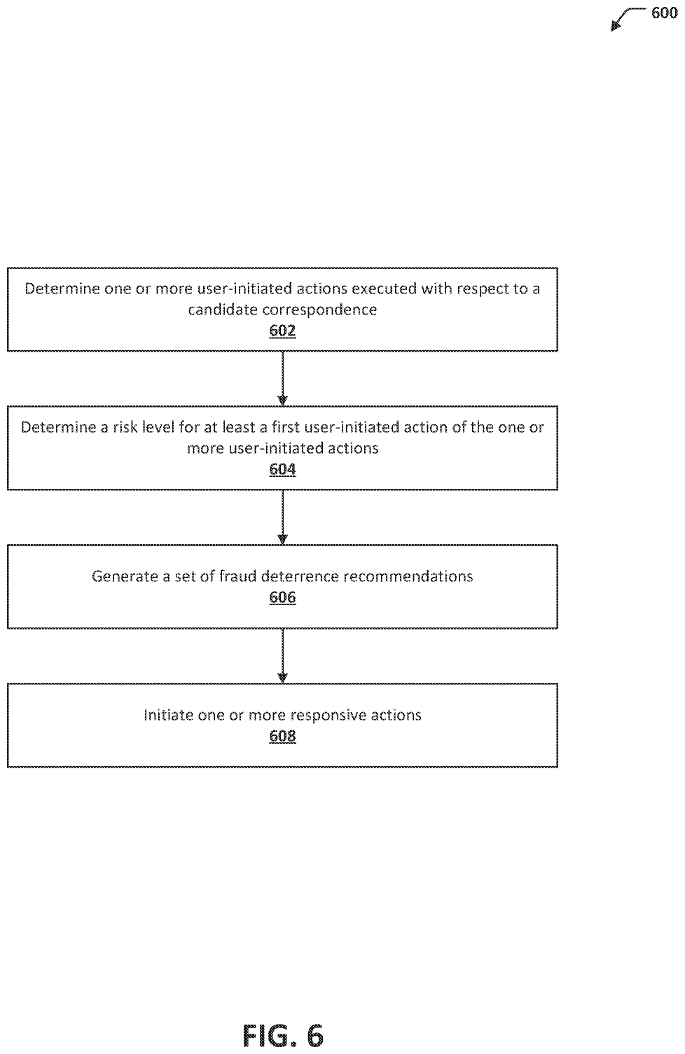

As described herein, the one or more fraud deterrence recommendations may comprise one or more actionable recommendations for mitigating the one or more fraud tactics associated with fraudulent correspondence. Some examples of fraud deterrence recommendations may include recommendations to report the correspondence to an information security team, delete the correspondence, abstain from clicking on hyperlinks associated with the correspondence, abstain from providing PII, change one or more passwords, enable two-factor authentication, check for unauthorized account activity, cease communication with an untrusted group or untrusted individual associated with the correspondence, initiate communication with a trusted individual or communication channel (e.g., via a software application instance associated with the correspondence fraud mitigation system 102, via a publicized telephone number available on an authentic enterprise website, etc.), freeze a respective user's credit, contact local authorities (e.g., law enforcement authorities, municipal authorities, etc.), document any details related to an interaction of a user and an untrusted group and/or untrusted individual, and/or the like. Additionally, FIG. 6 describes additional operations that may be performed to generate bespoke fraud deterrence recommendations for the user.

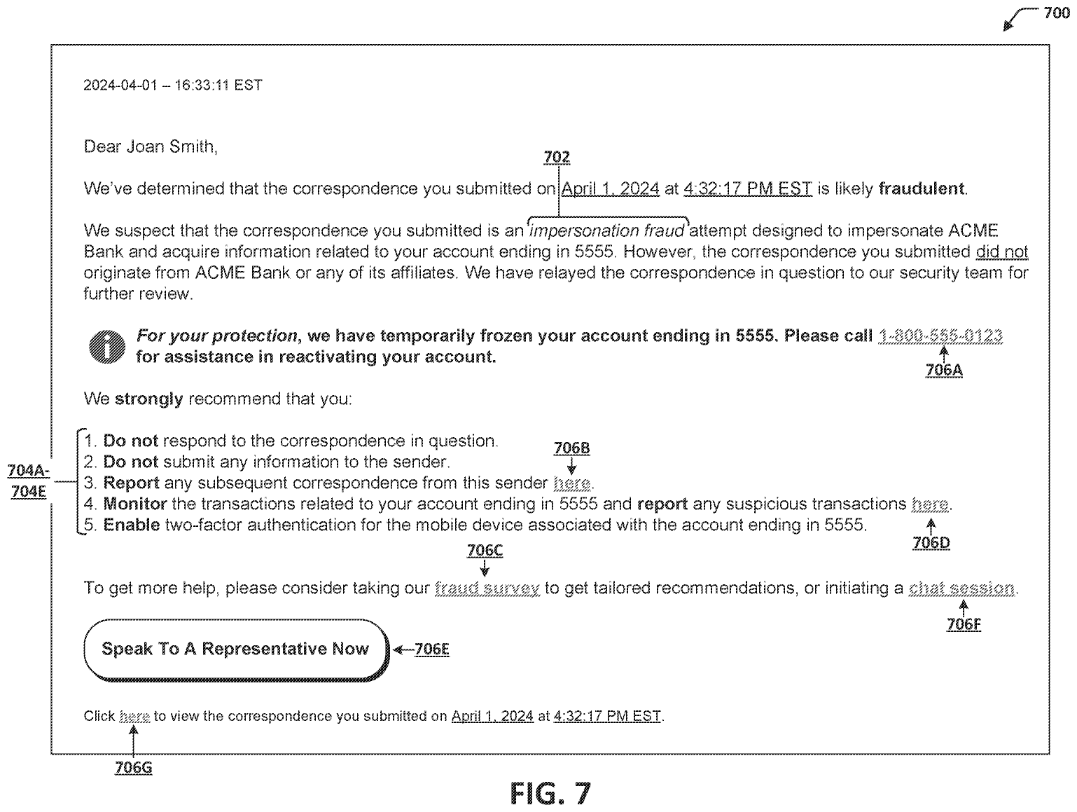

As shown by operation 416, the apparatus 200 may include means, such as processor 202, memory 204, communications hardware 206, correspondence fraud mitigation circuitry 208, fraud deterrence circuitry 214, and/or the like for providing the first set of fraud deterrence recommendations. For example, the correspondence fraud mitigation circuitry 208 may be configured to provide the first set of fraud deterrence recommendations (e.g., via the communications hardware 206) to a user device (e.g., user device 108A) of a user associated with the candidate correspondence. In this regard, the correspondence fraud mitigation circuitry 208 may be configured to cause display of one or more fraud deterrence recommendations generated by the fraud deterrence circuitry 214 based on a fraud classification associated with a respective candidate correspondence. In various examples, the one or more fraud deterrence recommendations may be associated with one or more interactive user interface elements of a software application instance associated with the correspondence fraud mitigation system 102 that are configured to initiate execution of one or more actions associated with the one or more fraud deterrence recommendations. An example of the provision of one or more fraud deterrence recommendations via a software application instance associated with the correspondence fraud mitigation system 102 is illustrated by FIG. 7.

Turning now to FIG. 7, an example user interface 700 is illustrated. In particular, the example user interface 700 details that a candidate correspondence submitted by a user via a user device (e.g., user device 108A) is likely fraudulent. As shown in FIG. 7, a fraud classification 702 has been determined for the candidate correspondence and, as shown, the example user interface 700 provides information related to the fraud classification 702. In the provided example, the fraud classification 702 is an impersonation fraud classification and the corresponding text explains that the candidate correspondence has attempted to impersonate a bank with which the user is associated in an attempt to acquire information related to a user account ending in 5555 owned by the user.

Furthermore, the example user interface 700 has been configured to inform the respective user that one or more actions have been automatically executed by the fraud deterrence model in order to mitigate the attempted impersonation fraud. For example, the example user interface 700 describes that the account ending in 5555 associated with the user has been temporarily frozen by the fraud deterrence model in order to mitigate any fraudulent activity related the user's account. Furthermore, the example user interface 700 provides an interactive user interface element 706A configured as a hyperlink to be utilized by the user to initiate communications (e.g., phone communications) between the user and a respective enterprise representative.

Additionally, as shown, the example user interface 700 has been configured to display fraud deterrence recommendations 704A-704E generated by the fraud deterrence model in order to mitigate the attempted impersonation fraud. As described herein, the fraud deterrence recommendations 704A-704E may be configured to advise the respective user to take various actions to stop and/or mitigate the attempted correspondence fraud. Additionally or alternatively, as described herein, the fraud deterrence recommendations 704A-704E may be associated with one or more interactive user interface elements 706A-706G configured to initiate the execution of one or more actions associated with the fraud deterrence recommendations 704A-704E and/or one or more actions to mitigate the attempted correspondence fraud.

For example, as shown, the interactive user interface element 706B is a hyperlink configured to facilitate the reporting of subsequent correspondence from a fraudster that has been received by the user. Additionally, as shown, the interactive user interface element 706D is a hyperlink configured to facilitate the reporting of any suspicious account activity (e.g., transaction activity) related to the account ending in 5555 owned by the user. Additionally, as shown, the interactive user interface element 706C is a hyperlink configured to facilitate the taking of a fraud survey configured to generate additional recommendation for the user. For example, the fraud survey may be a series of questions designed to solicit responses from a user that describe the level of interaction the user had with a particular candidate correspondence.

Additionally, as shown, the interactive user interface element 706F is a hyperlink configured to initiate a chat session (e.g., a chat session with a virtual assistant integrated with the fraud deterrence model). Additionally, as shown, the interactive user interface element 706E is an interactive button configured to initiate communications between the respective user and an enterprise representative. For example, the interactive user interface element 706E may be configured to initiate a video conference, telephone call, and/or the like between the respective user and an enterprise representative. Additionally, as shown, the interactive user interface element 706G is a hyperlink configured to cause the display of the candidate correspondence (e.g., the impersonation fraud correspondence) that was submitted by the user to the correspondence fraud mitigation system 102.

Returning now to FIG. 4, in various embodiments, the fraud deterrence circuitry 214 may be configured to leverage the fraud deterrence model to automatically execute one or more actions associated with the one or more fraud deterrence recommendations generated based on a particular fraudulent correspondence. Some examples of the fraud deterrence model automatically executing one or more actions associated with the one or more fraud deterrence recommendations may include causing the lockdown of a user account, causing transmission of one or more alerts associated with the fraudulent correspondence to an information security team associated with the enterprise (e.g., to one or more enterprise computing devices 106A-106N), causing enabling of two-factor authentication for a user device (e.g., user device 108A) associated with the user, and/or the like. In this regard, the fraud deterrence circuitry 214 may be configured to leverage the fraud deterrence model to determine a fraud severity level for the respective candidate correspondence and, based in part on the determined fraud severity level, initiate the automatic execution of one or more actions associated with the one or more fraud deterrence recommendations.

For example, in response to determining that the candidate correspondence is indeed fraudulent, the fraud deterrence circuitry 214 may cause the generation of one or more fraudulent correspondence alerts. In various embodiments, a fraudulent correspondence alert may be a notification, warning, and/or the like configured in a number of different formats (e.g., email, SMS message, banner alert, etc.) and transmitted (e.g., via communications hardware 206) to one or more computing devices associated with the correspondence fraud mitigation system 102 (e.g., one or more user devices 108A-108N, enterprise computing devices 106A-106N, and/or the like). In some examples, the fraud deterrence circuitry 214 may be configured to determine, based on the fraud severity level of candidate correspondence that has been determined to be fraudulent correspondence, at least one enterprise representative associated with an enterprise with which the user is associated. Furthermore, the fraud deterrence circuitry 214 may be configured to cause transmission of a fraudulent correspondence alert (e.g., via the communications hardware 206) associated with the fraudulent correspondence to an enterprise computing device (e.g., enterprise computing device 106A) associated with the at least one enterprise representative.

Furthermore, in some embodiments, the correspondence fraud mitigation circuitry 208 may cause the generation, storage, and/or transmission of data related to the fraudulent correspondence. For example, the correspondence fraud mitigation circuitry 208 may cause the storage of one or more of one or more correspondence content data features, fraud pattern data, fraud classification data, correspondence fault data, correspondence identification information, correspondence source data (e.g., identifying data, address data, computing device data, and/or the like related to the sender of the candidate correspondence), user data (e.g., data related to the recipient of the candidate correspondence), and/or the like associated with candidate correspondence that has been classified as fraudulent by the correspondence analysis model. In various embodiments, said data associated with the fraudulent correspondence may be employed by the correspondence analysis circuitry 212 and/or the fraud deterrence circuitry 214 to train or re-train the correspondence analysis model and/or fraud deterrence model respectively associated with the correspondence fraud mitigation system 102.

Additionally or alternatively, the correspondence fraud mitigation circuitry 208 may cause the generation and/or transmission of one or more reports describing the fraudulent correspondence. In some embodiments, the one or more reports describing the fraudulent correspondence may comprise one or more portions of data related to the one or more correspondence content data features, fraud pattern data, fraud classification data, correspondence fault data, correspondence identification information, correspondence source data, user data, and/or the like associated with candidate correspondence. The correspondence fraud mitigation circuitry 208 may cause the transmission of the one or more reports to one or more central entities responsible for monitoring, managing, mitigating, and/or otherwise tracking fraud patterns, fraud tactics, and/or fraudulent correspondence related to a particular domain with which the corresponding enterprise is associated (e.g., a central entity for mitigating fraud in the financial domain (e.g., credit card fraud, bank fraud, impersonation fraud, phishing, etc.).

Turning now to FIG. 5, example operations are shown for detecting correspondence inconsistencies in a candidate correspondence received by a respective user. As described herein, FIG. 5 illustrates some example implementations of operation 406 described herein with reference to FIG. 4.

As shown by operation 502, the apparatus 200 may include means, such as processor 202, memory 204, data management circuitry 210, correspondence analysis circuitry 212, and/or the like for comparing correspondence content data features associated with the candidate correspondence to ground-truth data associated with an enterprise with which the candidate correspondence is purported to have originated from. In some examples, the correspondence analysis circuitry 212 may leverage the data management circuitry 210 to facilitate the comparison of one or more correspondence content data features to the ground-truth data associated with the respective enterprise.

As described herein, the ground-truth data associated with an enterprise may comprise data related to one or more enterprise correspondence style rules (e.g., text formatting rules related to specific fonts, text emphasis, text decorations, text styles, etc.), correspondence tone (e.g., a professional tone, formal tone, informal tone, etc.), enterprise branding rules (e.g., requirements associated with logos, letterhead, icons, lexicon usage, etc.), enterprise product data (e.g., current product information, service information, promotion information, offer information, etc.), user data (e.g., user profile data, user account data, user identification data, etc.), user data obfuscation rules (e.g., rules for displaying PII, account information, credit card number information, etc.), correspondence delivery records (e.g., intended recipient data, originating correspondence source data, delivery timestamp data, expected arrival time data, etc.), domain knowledge data (e.g., financial domain data, technology domain data, business domain data, etc.), library of forms data (e.g., known enterprise form letters, known correspondence configurations, known fraudulent correspondence, known fraud patterns, etc.), and/or the like. In various embodiments, the ground-truth data managed by the data management circuitry 210 may be associated with, affiliated with, provided by, and/or otherwise managed by a third-party entity with which the enterprise is associated (e.g., a third-party research institution, domain oversight institution, enterprise competitor, and/or the like).

As shown by operation 504, the apparatus 200 may include means, such as processor 202, memory 204, correspondence fraud mitigation circuitry 208, data management circuitry 210, correspondence analysis circuitry 212, and/or the like for detecting one or more correspondence inconsistencies associated with the candidate correspondence. In various embodiments, a correspondence inconsistency may be a type of correspondence fault detected by the correspondence analysis model based on the one or more correspondence content data features associated with the candidate correspondence. A correspondence inconsistency may be a contradiction and/or error related to one or more portions of ground-truth data associated with an enterprise with which the candidate correspondence is purported to have originated from.

In some examples, a correspondence inconsistency may be a contradiction and/or error related to one or more enterprise correspondence style rules, correspondence tones, and/or enterprise branding rules associated with the respective enterprise. In various embodiments, a respective enterprise may have established requirements related to how correspondence is generated and/or presented to new and/or existing users. As a non-limiting example, the correspondence analysis circuitry 212 may be configured to leverage the correspondence analysis model to determine that an incorrect font has been used for the text in the candidate correspondence. As another non-limiting example, the correspondence analysis model may determine that an incorrect text style and/or emphasis has been used in the candidate correspondence (e.g., particular portions of the candidate correspondence have been incorrectly emboldened, italicized, underlined, and/or the like). As another non-limiting example, the correspondence analysis model may determine that an incorrect tone has been used in the candidate correspondence (e.g., an overly candid, unprofessional tone may have been used in the body of the candidate correspondence). As another non-limiting example, the correspondence analysis model may determine incorrect usage of an enterprise-approved lexicon in the candidate correspondence (e.g., a lack of enterprise keywords or vocabulary, misuse of enterprise keywords or vocabulary, and/or the like).

In some examples, a correspondence inconsistency may be a contradiction and/or error related to one or more user data obfuscation rules associated with the respective enterprise. In various embodiments, a respective enterprise may have established requirements related to how user data is displayed and/or referenced in various correspondence. As a non-limiting example, a respective enterprise may employ a user data obfuscation rule that requires that the last five digits of a 16-digit user account number associated with a respective user be preceded by eleven placeholder characters (e.g., “***********12345”) when referenced in correspondence. In such an embodiment, the correspondence analysis model may detect that an inappropriate number of placeholder characters has been used to obfuscate a user account number (e.g., the candidate correspondence may display the last four digits of a user account number rather than the expected five digits). Similar correspondence inconsistencies may pertain to the expected obfuscation of PII related to a user in correspondence including, but not limited to, contact information (e.g., phone numbers, email addresses, physical mailing addresses, etc.), information related to other parties associated with the user (e.g., beneficiaries, dependents, spouses, etc.), other account information (e.g., bank account balances, user profile identifiers, etc.), and/or the like.

In some examples, a correspondence inconsistency may be a contradiction and/or error related to user data associated with a respective user. For example, the data management circuitry 210 may be configured to receive, process, and/or otherwise manage user data related to one or more of user profile data (e.g., contact information, biological information, demographic information, etc.), user account data (e.g., account numbers, account status, bank account balance, account types, etc.), user identification data (e.g., PII), historical transaction data (e.g., purchase history data, subscription data, etc.), and/or the like associated with a respective user. As such, the correspondence analysis circuitry 212 may be configured to leverage the correspondence analysis model to determine one or more inconsistencies and/or errors associated with various user data comprised in the candidate correspondence. As a non-limiting example, the correspondence analysis model may detect an error related to an account number associated with the user (e.g., the last four digits of a displayed account number are incorrect) in the candidate correspondence. As another non-limiting example, the correspondence analysis model may detect one or more errors related to alleged account activity (e.g., alleged unauthorized purchases, historical transactions, expired bank cards, etc.) in the candidate correspondence.

In various examples, a correspondence inconsistency may be a contradiction and/or error related to enterprise product data associated with the respective enterprise. For example, the data management circuitry 210 may be configured to manage data related to each product, service, promotion, offer, deal, and/or the like currently being offered by the respective enterprise. As such, in various embodiments, the correspondence analysis model may determine there is one or more correspondence inconsistencies in the candidate correspondence if data related to outdated promotions, unoffered products and/or services, incorrect service terms, non-existent offers, incomplete product details, and/or the like are detected in the candidate correspondence.

In some examples, a correspondence inconsistency may be a contradiction and/or error related to one or more enterprise branding objects (e.g., image objects) associated with the respective enterprise. In various embodiments, a respective enterprise may have established requirements related to how certain branding objects are presented to new and/or existing users. In this regard, the correspondence analysis circuitry 212 may be configured to employ one or more image recognition techniques to analyze various logos, emblems, labels, imprints, signatures, stamps, trademarks, hallmarks, watermarks, icons, letterheads, badges, images, and/or any other branding objects comprised within the candidate correspondence. As such, the correspondence analysis model may be configured to compare one or more branding objects detected in the candidate correspondence to one or more known branding objects associated with the respective enterprise. As a non-limiting example, the correspondence analysis circuitry 212 may be configured to leverage the correspondence analysis model to determine that an old (e.g., outdated, retired) logo was used in the candidate correspondence that does not match a current logo associated with the enterprise. As another non-limiting example, the correspondence analysis model may be configured to determine that one or more colors associated with one or more branding objects detected in the candidate correspondence does not match a known (e.g., current) color scheme associated with the enterprise.

In various examples, a correspondence inconsistency may be a contradiction and/or error related to domain knowledge data related to a domain with which the enterprise is associated (e.g., the financial domain). For example, the data management circuitry 210 may be configured to receive, process, and/or otherwise manage data related to one or more known technologies, statistics, trends, statuses, grades, rates, figures of merit, and/or the like associated with the domain for which the enterprise is associated. As such, the correspondence analysis circuitry 212 may be configured to leverage the correspondence analysis model to determine one or more inconsistencies and/or errors associated with various domain knowledge data comprised in the candidate correspondence. As a non-limiting example, for an enterprise associated with the financial domain, the correspondence analysis model may detect incorrect data related to current interest rates, mortgage rates, savings interest rates, credit card interest rates, and/or any other current statistics, trends, rates, and/or the like associated with the financial domain in the candidate correspondence.

As shown by operation 506, the apparatus 200 may include means, such as processor 202, memory 204, data management circuitry 210, correspondence analysis circuitry 212, and/or the like for generating a set of fraud patterns associated with the candidate correspondence. For example, the correspondence analysis circuitry 212 may be configured to work in conjunction with the data management circuitry 210 to generate the set of fraud patterns based in part on a comparison of the one or more correspondence inconsistencies detected in the candidate correspondence to a set of known fraud patterns stored in a storage device associated with the correspondence fraud mitigation system 102. One or more of the known fraud patterns in the set of known fraud patterns may be associated with a common occurrence, recurrence, and/or instance of a particular correspondence inconsistency. As such, the correspondence analysis model may be configured to generate the set of fraud patterns based on comparing the one or more correspondence inconsistencies to the set of known fraud patterns. In this regard, in some embodiments, the set of fraud patterns may be a subset of the set of known fraud patterns.

As a non-limiting example, a correspondence inconsistency that violates an enterprise correspondence style rule (e.g., text formatting rule, text emphasis rule, text style rule, etc.) in a candidate correspondence may be a known fraud pattern associated with a respective fraud classification (e.g., phishing fraud). As another non-limiting example, a correspondence inconsistency that violates a user data obfuscation rule (e.g., a rule for displaying PII, account information, etc. associated with a user) in a candidate correspondence may be a known fraud pattern associated with a respective fraud classification (e.g., enterprise impersonation fraud). As yet another non-limiting example, a correspondence inconsistency associated with incorrect and/or outdated branding associated with an enterprise (e.g., inauthentic, inaccurate, and/or outdated logos, emblems, letterhead, images etc.) in a candidate correspondence may be a known fraud pattern associated with a respective fraud classification (e.g., bank fraud). As yet another non-limiting example, a correspondence inconsistency that violates a standardized correspondence tone associated with an enterprise (e.g., false urgency, threatening, incorrect lexicon, etc.) in a candidate correspondence may be a known fraud pattern associated with a respective fraud classification (e.g., extortion, intimidation, etc.).

Turning next to FIG. 6, flowchart 600 illustrates example operations for determining user-initiated actions in order to generate fraud deterrence recommendations.

As shown by operation 602, the apparatus 200 may include means, such as processor 202, memory 204, communications hardware 206, fraud deterrence circuitry 214, and/or the like for determining one or more user-initiated actions executed with respect to a candidate correspondence. In various embodiments, the fraud deterrence circuitry 214 may be configured to leverage a fraud deterrence model associated with the correspondence fraud mitigation system 102 to determine one or more user-initiated actions executed with respect to a candidate correspondence. The one or more user-initiated actions are characterized by an engagement of the user with the candidate correspondence. Some examples of a user-initiated action may include clicking on a hyperlink associated with the candidate correspondence (e.g., a link comprised within an email), providing PII or other user data to an untrusted group and/or individual that sent the candidate correspondence, responding to the candidate correspondence (e.g., responding to one or more instructions in printed correspondence), and/or any other engagement with the candidate correspondence by the user.

In various other embodiments, the fraud deterrence circuitry 214 may be configured to leverage a fraud deterrence model to generate a set of risk determination questions configured to determine if the user performed one or more user-initiated actions in response to receiving the candidate correspondence. Furthermore, in some embodiments, the one or more risk determination questions may be generated based on the fraud classification of the candidate correspondence. For example, a first set of risk determinations questions may be generated based on a determination that the candidate correspondence is associated with a phishing fraud classification, whereas a second (e.g., different) set of risk determination questions may be generated based on a determination that the candidate correspondence is associated with enterprise impersonation fraud. Additionally or alternatively, in various embodiments, one or more second risk determination questions may be generated in based on one or more respective user responses to one or more first risk determination questions.

In this regard, the correspondence fraud mitigation circuitry 208 (e.g., in conjunction with the communications hardware 206) may be configured to facilitate one or more virtual communications sessions between the user and a virtual assistant or chat-bot that is configured to integrate with the fraud deterrence model. For example, a virtual assistant integrated with the fraud deterrence model may be configured to communicate with the user (e.g., via a generative AI-based chat session, AI-generated audio communications, text-based prompts, etc.) to determine one or more user-initiated actions that have been executed with respect to candidate correspondence. As such, in various embodiments, the fraud deterrence model may be configured to communicate with the user (e.g., via the virtual assistant) in real time or near-real time and present one or more risk determination questions to determine the extent to which the user has engaged with the candidate correspondence.

Some examples of risk determination questions may include, “When did you receive the correspondence?”, “Have you received similar correspondence in the past?”, “Did you click any links in the correspondence?”, “Did you click on the XYZ button in the correspondence?”, “Do you recognize the sender of the correspondence?”, “Did you provide personally identifiable information to the sender of the correspondence?(e.g., account information, contact information, etc.?)”, “Did you forward the correspondence to anyone else?” and/or the like. In this regard, the fraud deterrence model may be configured to solicit and/or receive (e.g., by way of the virtual communications session facilitated by the correspondence fraud mitigation circuitry 208) various user responses and/or user input (e.g., text input, audio input, selection input, etc.) to one or more risk determination questions configured to determine the one or more user-initiated actions performed with respect to the candidate correspondence.

As shown by operation 604, the apparatus 200 may include means, such as processor 202, memory 204, fraud deterrence circuitry 214, and/or the like for determining a risk level for at least a first user-initiated action of the one or more user-initiated actions. In various embodiments, a risk level associated with a user-initiated action may be a classification and/or indication of a level of criticality associated with the user-initiated action that describes an amount of risk the user has incurred by performing the user-initiated action.

As a non-limiting example, a first user-initiated action associated with providing a first tier of PII (e.g., a user's name or contact information) may be associated with a first risk level, whereas a second user-initiated action associated with providing a second tier of PII (e.g., a social security number, birthdate, account number) may be associated with a second risk level that higher relative to the first risk level. Continuing the above example, a third user-initiated action associated with clicking a link in the candidate correspondence may be associated with third risk level that is a higher risk level relative to the first risk level associated with the first user-initiated action yet is a lower risk level than the second risk level associated with the second user-initiated action. In the above example, the third risk level associated with the third user-initiated action (e.g., clicking a hyperlink in the correspondence) may be relatively lower than the second risk level associated with the second user-initiated action (e.g., providing second tier PII (e.g., social security number, birthdate, account number)) as the security implications associated with the second user-imitated action are higher. For example, if the user has provided their social security number and/or account number to a fraudster, the fraudster may have enough information open a fraudulent account (e.g., a credit card account, etc.), apply for a loan, and/or the like using the identity of the user.

As shown by operation 606, the apparatus 200 may include means, such as processor 202, memory 204, fraud deterrence circuitry 214, and/or the like for generating a set of fraud deterrence recommendations. In various embodiments, the fraud deterrence circuitry 214 may be configured to leverage the fraud deterrence model to generate a first set of fraud deterrence recommendations based on one or more fraud patterns and/or a fraud classification associated with the candidate correspondence and generate a second set of fraud deterrence recommendations based on one or more user-initiated actions performed with respect to the candidate correspondence.

In this regard, the fraud deterrence circuitry 214 may be configured to leverage the fraud deterrence model to generate a set of fraud deterrence recommendations based in part on the risk levels associated with the respective one or more user-initiated actions performed with respect to the candidate correspondence. As a non-limiting example, the fraud deterrence model may generate a first fraud deterrence recommendation in response to determining a first risk level for a first user-initiated action (e.g., clicking on a hyperlink in the candidate correspondence) and generate a second fraud deterrence recommendation in response to determining a second risk level for a second user-initiated action (e.g., providing second tier PII (e.g., social security number, birthdate, account number)). In such an example, as the risk level associated with the first user-initiated action may be relatively low, the first fraud deterrence recommendation may be a recommendation to cease any further engagement with the candidate correspondence and/or cease any communications with the sender of the candidate correspondence. Continuing the above example, as the risk level associated with the second user-initiated action may be relatively high, the second fraud deterrence recommendation may be a recommendation to freeze one or more accounts associated with the user, monitor any changes to the user's credit (e.g., as the changes may indicate an application for a loan, a line a credit, etc.), generate a new account for the user, and/or the like.

As shown by operation 608, the apparatus 200 may include means, such as processor 202, memory 204, correspondence fraud mitigation circuitry 208, fraud deterrence circuitry 214, and/or the like for initiating one or more responsive actions related to the set of fraud deterrence recommendations. For example, the correspondence fraud mitigation circuitry 208 may be configured to cause transmission of the set of fraud deterrence recommendations (e.g., via the communications hardware 206) to a user device (e.g., user device 108A) of a user associated with the candidate correspondence. In this regard, the correspondence fraud mitigation circuitry 208 may be configured to cause display of one or more fraud deterrence recommendations generated by the fraud deterrence circuitry 214 based on an indication of the performance of one or more user-initiated actions with respect to candidate correspondence (e.g., via a virtual communications session between the user and a virtual assistance integrated with the fraud deterrence model).

Additionally, the fraud deterrence circuitry 214 may be configured to leverage the fraud deterrence model to automatically execute one or more actions associated with the one or more fraud deterrence recommendations generated based on a respective risk level associated with one or more user-initiated actions. As a non-limiting example, the fraud deterrence model may automatically cause the lockdown of a user account if a user-initiated action associated with a high risk level is determined to have been performed (e.g., a user has provided sensitive account information such as login information, account numbers, etc. in response to receiving candidate correspondence). As another non-limiting example, the fraud deterrence model may automatically cause the enabling of two-factor authentication for a user device (e.g., user device 108A) associated with the user based on one or more user-initiated actions performed with respect to the candidate correspondence. As another non-limiting example, the fraud deterrence model may automatically cause the transmission of one or more alerts associated with the fraudulent correspondence to one or more enterprise computing devices (e.g., enterprise computing devices 106A-106N) of an information security team associated with an enterprise with which the user is affiliated.

Additionally or alternatively, the correspondence fraud mitigation system 102 may be configured to monitor one or more user devices (e.g., user devices 108A-108N), one or more user accounts, a user profile, and/or the like associated with a user after a determination that fraudulent correspondence has been transmitted to the user. As such, one or more components of the correspondence fraud mitigation system 102 (e.g., the data management circuitry 210, the correspondence analysis circuitry 212, etc.) may be leveraged to monitor the one or more user devices, one or more user accounts, the user profile, and/or the like associated with a user for a predefined monitoring period (e.g., one week, two weeks, one month, six months, etc.) to detect additional fraudulent activity associated with the user. As such, the correspondence fraud mitigation system 102 may be configured to generate one or more additional fraud deterrence recommendations for the user during the predefined monitoring period based on various user activity (e.g., one or more user-initiated actions) and/or suspicious activity (e.g., additional fraudulent correspondence) related to the user.

Furthermore, in various embodiments, the correspondence fraud mitigation system 102 may be configured to keep track of a user's engagement with various fraudulent correspondence. For example, if a user continuously engages with fraudulent correspondence after being educated and/or or warned (e.g., after receiving multiple sets of fraud deterrence recommendations, after having one or more actions related to fraud deterrence recommendations executed on the user's behalf, etc.), the correspondence fraud mitigation system 102 may be configured to execute various actions. For instance, if a particular user continuously engages with fraudulent correspondence, the correspondence fraud mitigation system 102 may be configured to remove one or more user access privileges associated with the user's accounts, change an account type of the user, issue the user a new account with added protections, levy additional security rules on the user's accounts, limit one or more device and/or account functionalities, and/or the like.

FIGS. 4-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide systems, methods, and apparatuses that enable improved correspondence fraud mitigation. Example embodiments thus provide tools that overcome the problems faced by conventional fraud mitigation mechanisms which, in some scenarios, require additional attention and effort on the part of the user to determine whether a particular candidate correspondence is fraudulent. By avoiding the use of conventional fraud mitigation mechanisms, example embodiments thus save time and resources, while also eliminating the possibility of a user engaging with fraudulent correspondence by mistake. Moreover, embodiments described herein counter a wide variety of emerging risks in an evolving technological landscape.

For instance, example embodiments provide protection against enterprise impersonation attempts configured to fraudulently solicit user data and/or enterprise data by intentionally misleading a user to believe they are being contacted by an enterprise with which they are affiliated. Furthermore, example embodiments provide protection against fraudulent correspondence configured in a variety of formats (e.g., print formats, digital formats, etc.). For example, as described herein, example embodiments leverage a software application instance associated with the correspondence fraud mitigation system in order to facilitate the imaging and/or scanning, submission, and authentication of printed correspondence (e.g., printed correspondence received by mail).

By employing the AI-based correspondence fraud mitigation model described herein, users are able to verify that the data and/or requested actions in the candidate correspondence are authentic. For instance, the correspondence fraud mitigation model may be employed to detect various errors and/or correspondence inconsistencies in the candidate correspondence that contradict various enterprise guidelines and/or ground-truths and may not be readily apparent to a user who has received the candidate correspondence. Furthermore, example embodiments leverage AI technologies to make the correspondence fraud mitigation system described herein more robust against future correspondence fraud by storing known fraudulent correspondence and/or potentially fraudulent correspondence in a library of forms (e.g., in addition to known enterprise correspondence) that can be used to evaluate future candidate correspondence submitted users.

As these examples all illustrate, example embodiments contemplated herein provide technical solutions that solve real-world problems faced by users receiving potentially fraudulent correspondence in a variety of formats. And while fraud such as enterprise impersonation and phishing has been an issue for years, the ubiquitous use of form letters, direct mail (in digital and print formats), and network-accessible data related to both enterprises and individuals has made this problem significantly more acute, especially as fraud techniques become more sophisticated. At the same time, the recently arising ubiquity of AI-based technologies has unlocked new avenues to solving these problems that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for mitigating correspondence fraud, the method comprising:
receiving, by communications hardware, candidate correspondence associated with a user;
extracting, by correspondence analysis circuitry, one or more correspondence content data features from the candidate correspondence;
determining, by the correspondence analysis circuitry and based on the one or more correspondence content data features, a set of fraud patterns comprising one or more fraud patterns associated with the candidate correspondence;
determining, by the correspondence analysis circuitry and based on the set of fraud patterns, a fraud classification for the candidate correspondence;
in an instance in which the fraud classification is not indicative of an authentic communication, generating, by fraud deterrence circuitry and based on the fraud classification, a first set of fraud deterrence recommendations; and
providing, by the communications hardware, the first set of fraud deterrence recommendations to one or more computing devices.

2. The method of claim 1, wherein determining the set of fraud patterns further comprises:
generating, by the correspondence analysis circuitry and based on one or more of the one or more correspondence content data features, a set of correspondence faults comprising one or more correspondence faults associated with the candidate correspondence;
comparing, by the correspondence analysis circuitry, the set of correspondence faults to a set of known fraud patterns; and
generating, by the correspondence analysis circuitry and based on comparing the set of correspondence faults to the set of known fraud patterns, the set of fraud patterns, wherein the set of fraud patterns is a subset of the set of known fraud patterns.

3. The method of claim 2, wherein generating the set of correspondence faults comprises:
determining, by the correspondence analysis circuitry, a correspondence content data feature type for a correspondence content data feature; and
executing, by the correspondence analysis circuitry and based on the correspondence content data feature type, one or more of a hyperlink evaluation routine, HyperText Markup Language (HTML) element evaluation routine, image metadata evaluation routine, page script evaluation routine, source code evaluation routine, or correspondence source address evaluation routine with respect to the candidate correspondence.

4. The method of claim 1, wherein determining the set of fraud patterns further comprises:
comparing, by the correspondence analysis circuitry, the one or more correspondence content data features associated with the candidate correspondence to ground-truth data associated with an enterprise;
detecting, by the correspondence analysis circuitry and based on comparing the one or more correspondence content data features to the ground-truth data, one or more correspondence inconsistencies;
comparing, by the correspondence analysis circuitry, the one or more correspondence inconsistencies to a set of known fraud patterns; and
generating, by the correspondence analysis circuitry and based on comparing the one or more correspondence inconsistencies to the set of known fraud patterns, the set of fraud patterns associated with the candidate correspondence, wherein the set of fraud patterns is a subset of the set of known fraud patterns.

5. The method of claim 4, wherein the ground-truth data comprises data related to one or more correspondence style rules, branding rules, product data, user data, user data obfuscation rules, correspondence delivery records, or knowledge domain data.

6. The method of claim 1, wherein determining the fraud classification further comprises:
generating, by the correspondence analysis circuitry and based on the set of fraud patterns, a fraud classification probability for at least one fraud classification of a plurality of fraud classifications;
determining, by the correspondence analysis circuitry, whether the fraud classification probability satisfies a fraud classification threshold; and
in response to determining that the fraud classification probability satisfies the fraud classification threshold:
classifying, by the correspondence analysis circuitry, the candidate correspondence based on the at least one fraud classification.

7. The method of claim 1, further comprising:
determining, by the fraud deterrence circuitry, one or more user-initiated actions executed with respect to the candidate correspondence, wherein the one or more user-initiated actions are characterized by an engagement of the user with the candidate correspondence;
determining, by the fraud deterrence circuitry and based on the fraud classification, a risk level for a first user-initiated action of the one or more user-initiated actions;
generating, by the fraud deterrence circuitry and based in part on the risk level of the first user-initiated action, a second set of fraud deterrence recommendations; and
providing, by the communications hardware, the second set of fraud deterrence recommendations to a computing device associated with the user.

8. The method of claim 7, wherein determining the one or more user-initiated actions further comprises:
generating, by the fraud deterrence circuitry and based on the fraud classification, a set of risk determination questions configured to determine if the user performed one or more actions in response to receiving the candidate correspondence;
providing, by the communications hardware, of at least a first risk determination question of the set of risk determination questions to the computing device associated with the user;
receiving, by the communications hardware, at least a first user response to the first risk determination question; and
determining, by the fraud deterrence circuitry and based in part on the first user response to the first risk determination question, the one or more user-initiated actions executed by the user with respect to the candidate correspondence.

9. The method of claim 7, further comprising:
determining, by the fraud deterrence circuitry and based on the fraud classification of the candidate correspondence, a fraud severity level for the candidate correspondence; and
automatically executing, by the fraud deterrence circuitry and based on the fraud severity level of the candidate correspondence, at least one action associated with at least one fraud deterrence recommendation of the first set of fraud deterrence recommendations or the second set of fraud deterrence recommendations.

10. The method of claim 9, further comprising:
determining, by the fraud deterrence circuitry and based on the fraud severity level of the candidate correspondence, at least one enterprise representative associated with an enterprise with which the user is associated; and
providing, by the communications hardware, a correspondence fraud alert associated with the candidate correspondence to an enterprise computing device associated with the at least one enterprise representative.

11. The method of claim 1, wherein the candidate correspondence is a digital representation of printed correspondence.

12. The method of claim 1, wherein the candidate correspondence is audio correspondence, and wherein the audio correspondence is received by a computing device associated with the user.

13. An apparatus for mitigating correspondence fraud, the apparatus comprising:
communications hardware configured to:
receive candidate correspondence associated with a user;
correspondence analysis circuitry configured to:
extract one or more correspondence content data features from the candidate correspondence;
determine, based on the one or more correspondence content data features, a set of fraud patterns comprising one or more fraud patterns associated with the candidate correspondence; and
determine, based on the set of fraud patterns, a fraud classification for the candidate correspondence; and
fraud deterrence circuitry configured to:
in an instance in which the fraud classification is not indicative of an authentic communication, generate, based on the fraud classification, a first set of fraud deterrence recommendations, wherein the communications hardware is configured to provide the first set of fraud deterrence recommendations to one or more computing devices.

14. The apparatus of claim 13, wherein the correspondence analysis circuitry is further configured to:
generate, based on one or more of the one or more correspondence content data features, a set of correspondence faults comprising one or more correspondence faults associated with the candidate correspondence;
compare the set of correspondence faults to a set of known fraud patterns; and
generate, based on comparing the set of correspondence faults to the set of known fraud patterns, the set of fraud patterns, wherein the set of fraud patterns is a subset of the set of known fraud patterns.

15. The apparatus of claim 14, wherein the correspondence analysis circuitry is further configured to:
determine a correspondence content data feature type for a correspondence content data feature; and
execute, based on the correspondence content data feature type, one or more of a hyperlink evaluation routine, HyperText Markup Language (HTML) element evaluation routine, image metadata evaluation routine, page script evaluation routine, source code evaluation routine, or correspondence source address evaluation routine with respect to the candidate correspondence.

16. The apparatus of claim 13, wherein the correspondence analysis circuitry is further configured to:
compare the one or more correspondence content data features associated with the candidate correspondence to ground-truth data associated with an enterprise;
detect, based on comparing the one or more correspondence content data features to the ground-truth data, one or more correspondence inconsistencies;
compare, the one or more correspondence inconsistencies to a set of known fraud patterns; and
generate, based on comparing the one or more correspondence inconsistencies to the set of known fraud patterns, the set of fraud patterns associated with the candidate correspondence, wherein the set of fraud patterns is a subset of the set of known fraud patterns.

17. The apparatus of claim 16, wherein the ground-truth data comprises data related to one or more correspondence style rules, branding rules, product data, user data, user data obfuscation rules, correspondence delivery records, or knowledge domain data.

18. The apparatus of claim 13, wherein the correspondence analysis circuitry is further configured to:
generate, based on the set of fraud patterns, a fraud classification probability for at least one fraud classification of a plurality of fraud classifications;
determine whether the fraud classification probability satisfies a fraud classification threshold; and
in response to determining that the fraud classification probability satisfies the fraud classification threshold:
classify the candidate correspondence based on the at least one fraud classification.

19. The apparatus of claim 13, wherein the fraud deterrence circuitry is further configured to:
determine one or more user-initiated actions executed with respect to the candidate correspondence, wherein the one or more user-initiated actions are characterized by an engagement of the user with the candidate correspondence;
determine, based on the fraud classification, a risk level for a first user-initiated action of the one or more user-initiated actions; and
generate, based in part on the risk level of the first user-initiated action, a second set of fraud deterrence recommendations;
wherein the communications hardware is further configured to:
provide the second set of fraud deterrence recommendations to a computing device associated with the user.

20. A computer program product for mitigating correspondence fraud, the computer program product comprising at least one non-transitory computer-readable storage medium storing software instructions that, when executed, cause an apparatus to:
receive candidate correspondence associated with a user;
extract one or more correspondence content data features from the candidate correspondence;
determine, based on the one or more correspondence content data features, a set of fraud patterns comprising one or more fraud patterns associated with the candidate correspondence;
determine, based on the set of fraud patterns, a fraud classification for the candidate correspondence;
in an instance in which the fraud classification is not indicative of an authentic communication, generate, based on the fraud classification, a first set of fraud deterrence recommendations; and
provide the first set of fraud deterrence recommendations to one or more computing devices.
